(19) United States
(12) Patent Application Publication
(10) Pub. No.: US 2023/0013578 A1
(43) Pub. Date: Jan. 19, 2023

(54) COMPOSITION FOR HOLOGRAM RECORDING, HOLOGRAM RECORDING MEDIUM, HOLOGRAM, AND OPTICAL DEVICE AND OPTICAL MEMBER USING SAME

(71) Applicant: SONY GROUP CORPORATION, TOKYO (JP)

(72) Inventors: SAE MIYAJI, TOKYO (JP); KAORI ASANO, KANAGAWA (JP); MASAKAZU UKITA, TOKYO (JP); KENSHIRO KAWASAKI, TOKYO (JP); TAKAHIRO OHE, TOKYO (JP); HISAYA HARA, TOKYO (JP)

(21) Appl. No.: 17/755,593

(22) PCT Filed: Oct. 6, 2020
(86) PCT No.: PCT/JP2020/037845

§ 371 Date: May 3, 2022

(30) Foreign Application Priority Data
Nov. 11, 2019 (JP) 2019-203818

(51) Int. Cl. G03H 1/00; G03H 1/02; C08F 2/44

(52) U.S. Cl. CPC G03H 1/0005; G03H 1/02; C08F 2/44; G03H 2260/12; G03H 2001/0264; G03H 2001/005

(57) ABSTRACT

The present invention provides a composition for hologram recording, a hologram recording medium and a hologram that are capable of realizing excellent diffraction characteristics and an optical device and an optical member using same. The present invention is capable of providing a composition for hologram recording containing at least a radical polymerizable monomer and a matrix resin, in which a cross-sectional observation image at the time of observing a hologram recording film by atomic force microscopy (AFM) has a diffraction grating structure indicating that there is a material density difference that can be observed by the AFM.

### TECHNICAL FIELD

The present technique relates to a composition for hologram recording, a hologram recording medium, a hologram, and an optical device and an optical member using same.

### BACKGROUND ART

Holograms are images in which a bright and dark (interference) pattern of light is recorded in a photosensitive material or the like as a pattern of a refractive index or the like and are in broad use in the fields of optical information processing, security, medical science, head up displays and the like. Holograms are capable of recording a large amount of three-dimensional information relating to objects as light information and are thus gaining attention as next-generation recording media.

Thus far, there have been a variety of proposals regarding materials for holograms. For example, PTL 1 proposes a photosensitive material containing a polymer matrix formed by the radical polymerization of a radical polymerizable compound in the presence of a radical polymerization initiator, a photocationic polymerization initiator and a cationic polymerizable compound, in which the reduction potential of the photocationic polymerization initiator is lower than the oxidation potential of a radical generated from the radical polymerization initiator.

In addition, holograms are classified into several types depending on the recording formats of interference fringes, and recently, volume holograms that record interference fringes with the amounts of refractive index modulation in a recording layer are being applied in applications such as three-dimensional displays or optical elements due to the high diffraction efficiency or excellent wavelength selectivity.

For example, PTL 2 and 3 disclose compositions and production methods of volume hologram recording materials.

### CITATION LIST

### Patent Literature

[PTL 1]
JP 2010-210654 A
[PTL 2]
JP H5-107999 A
[PTL 3]
JP H6-43634 A

### Non Patent Literature

[NPL 1]
J. Yoon, W Lee, E. L. Thomas. Nano Letters 2006, 6(10) 2211-2214
[NPL 2]
B. M-Jensen, S. Robu, A. Rivaton et al. Int. J. Photoenergy, Vol. 2010, Article ID 945242, doi:10.1155/2010/945242
[NPL 3]
A. Mazzulla, P. Pagliusi, C. Provenzano, G. Russo, G. Carbone and G. Cipparrone, Appl. Phys. Lett. 2004, 85 (13), 2505 to 2507
[NPL 4]
KENBIKYO Vol. 44, No. 2 (2009) 145 to 149, Ken Nakajima et al. “Recent Research and Technology, AFM Characterization for Mechanical Properties of Polymeric Materials”

### SUMMARY

### Technical Problem

In hologram techniques, there is a demand for excellent diffraction characteristics.

Therefore, a main objective of the present technique is to provide a composition for hologram recording, a hologram recording medium and a hologram that are capable of realizing excellent diffraction characteristics and an optical device and an optical member using same.

### Solution to Problem

As a result of intensive studies for achieving the above-described objective, the present inventors found a hologram technique capable of realizing excellent diffraction characteristics and completed the present technique.

That is, the present technique is capable of providing a composition for hologram recording containing at least a radical polymerizable monomer and a matrix resin,

in which a cross-sectional observation image at the time of observing a hologram recording film by atomic force microscopy (AFM) has a diffraction grating structure indicating that there is a material density difference that can be observed by the AFM.

The composition for hologram recording may be a configuration in which, when the cross-sectional observation image has been Fourier-transformed, a periodic structure-derived peak is observed at a wavenumber position with a different origin of a power spectrum.

The composition for hologram recording may be a configuration in which the periodic structure-derived peak is three or more times higher than a noise waveform of a baseline.

An amount of refractive index modulation Δn may be 0.04 or more.

A clarity of the diffraction grating structure may be 2 nm or more.

The composition for hologram recording may be further a polymerization inhibitor and/or an anthracene-based compound.

The radical polymerizable monomer may be a plurality of radical polymerizable monomers having different refractive indexes.

In addition, the present technique is capable of providing a hologram recording medium containing at least a radical polymerizable monomer and a matrix resin and

having a photocurable resin layer in which a cross-sectional observation image at the time of observing a hologram recording film by atomic force microscopy (AFM) has a diffraction grating structure indicating that there is a material density difference that can be observed by the AFM.

In addition, the present technique is capable of providing a hologram recording film in which a cross-sectional observation image at the time of observing a hologram recording film by atomic force microscopy (AFM) has a diffraction grating structure indicating that there is a material density difference that can be observed by the AFM.

In addition, the present technique is capable of providing a hologram obtained using the hologram recording medium.

In addition, the present technique is capable of providing an optical device having the hologram.

In addition, the present technique is capable of providing an optical member having the hologram.

### BRIEF DESCRIPTION OF DRAWINGS

FIG. 1 is a cross-sectional view schematically showing an example of a hologram recording medium according to an embodiment of the present technique.

FIG. 2 is an example of the preparation of a specimen of a hologram recording film in the present technique for atomic force microscopy (AFM) and a view schematically showing the summary of an order of the preparation.

FIG. 3 is a view of a cross-sectional observation image of a hologram recording film of an embodiment of the present technique by the atomic force microscopy (AFM), in which the diffraction grating structure of the film is periodic (stripe pattern). Oblique lines indicate the direction of the stripe pattern.

FIG. 4 is a view of the observation image of the cross-sectional observation image of the hologram recording film of the embodiment of the present technique two-dimensionally Fourier-transformed after the atomic force microscopy (AFM). The observation image is an example of an observation image indicating that a peak derived from a periodic structure is present.

FIG. 5 is a view showing whether or not a peak derived from a periodic structure is present in a hologram recording film according to an embodiment of the present technique, in which the upper drawings show Experiment Example 1 (example) and the lower drawings show Experiment Example 5 (comparative example).

FIG. 6 is a shape image of a cross-sectional observation image in the hologram recording film (Experiment Example 1) according to the embodiment of the present technique (FIG. 6A). FIG. 6B is a graph of a diffraction grating structure portion in the shape image of the cross-sectional observation image transformed to clarity.

### DESCRIPTION OF EMBODIMENTS

Hereinafter, preferable embodiments for carrying out the present technique will be described with appropriate reference to drawings.

The embodiments to be described below simply show examples of the representative embodiments of the present technique and do not make the scope of the present technique narrowly interpreted. The description will be made in the following order. Regarding the drawings, the same or equivalent element or member will be given the same reference sign and will not be described again.

1. Summary of present technique
2. First embodiment (composition for hologram recording)
2-1. Characteristics of diffraction grating structure of composition for hologram recording
2-2. Components of composition for hologram recording
2-2-1. Radical polymerizable monomer
2-2-2. Matrix resin
2-2-3. Photopolymerization initiator
2-2-4. Anthracene-based compound

### 2-2-5. Plasticizer

2-2-6. Polymerization inhibitor
2-2-7. Other components
2-3. Method for producing composition for hologram recording
3. Second embodiment (hologram recording medium)
3-1. Hologram recording medium
3-2. Photocurable resin layer
3-3. Transparent base material
3-4. Method for manufacturing hologram recording medium
4. Third embodiment (hologram)

### 4-1. Hologram

4-2. Method for producing hologram
5. Fourth embodiment (optical device and optical member)

### 1. Summary of Present Technique

First, the summary of the present technique will be described.

The present technique relates to a composition for hologram recording, a hologram recording medium, a hologram, and an optical device and an optical member using same.

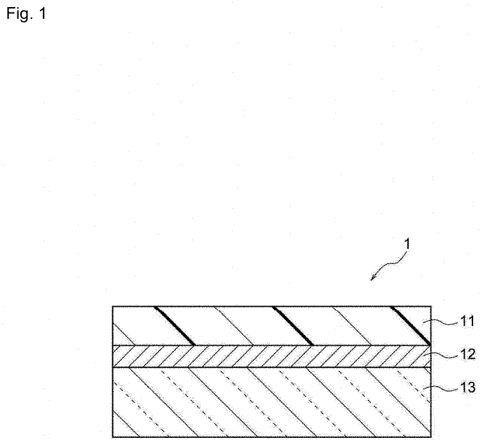

Here, a schematic cross-sectional view of an example of a hologram recording medium of the present embodiment will be shown in FIG. 1, but the hologram recording medium of the present embodiment is not limited thereto.

A hologram recording medium 1 shown in FIG. 1 is configured in a three-layer structure in which a photocurable resin layer 12 is disposed between a transparent protective film 11 (transparent base material) and a glass or film substrate (transparent base material) 13. As described above, the hologram recording medium of the present embodiment may be configured in a three-layer structure in which a photocurable resin layer is formed on a first transparent base material and a second transparent base material is further formed on the main surface of the photocurable resin layer, and, at this time, the first and second transparent base materials may be different from each other.

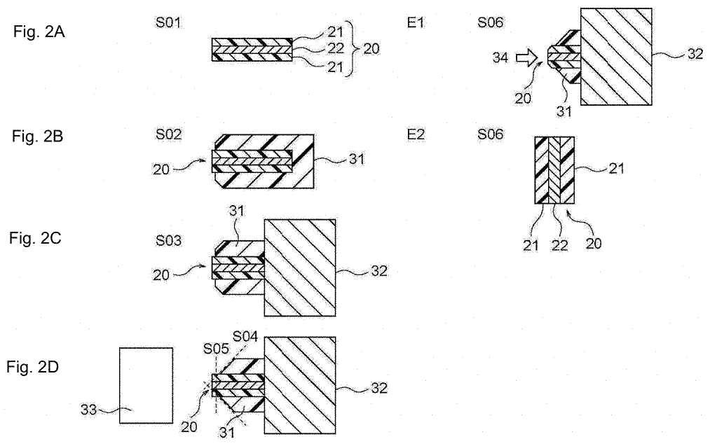

A hologram 20 can be formed by carrying out exposure, UV irradiation and the like on the hologram recording medium 1, and, at this time, a hologram recording film 22 can be formed from the photocurable resin layer 12. At this time, the transparent protective film (transparent base material) is indicated by a reference sign 21, and the glass or film substrate (transparent base material) is indicated by a reference sign 23 (refer to FIG. 2A). The hologram of the present embodiment is not particularly limited, and FIG. 2A shows a schematic cross section of an example of the hologram of the present embodiment.

Here, the hologram is an image in which two light rays (object light and reference light) having the same wavelength are caused to interfere with each other to record the wavefront of the object light in a photosensitive material as interference fringes, and, when light having the same condition as the original reference light is poured on this hologram, a diffraction phenomenon caused by the interference fringes occurs, and the same wavefront as that of the original object light can be reproduced.

Holograms are classified into several types depending on the recording formats of interference fringes, and, recently, volume holograms that record interference fringes with the amounts of refractive index modulation in a recording layer are being applied in applications such as three-dimensional displays or optical elements due to the high diffraction efficiency or excellent wavelength selectivity.

For example, PTL 2 and 3 disclose compositions for volume hologram recording and production methods, but the amounts of refractive index modulation Δn shown in the examples thereof are less than 0.02.

However, for hologram recording films for the applications of AR and VR-oriented three-dimensional displays, the need of which has been rising recently, there is a demand for an increase in brightness and additional improvement in the amount of refractive index modulation Δn.

As described in PTL 2 and 3, a composition for volume hologram recording contains a monomer and a matrix, which have different amounts of refractive index modulation, a photopolymerization initiator or the like, and polymerization proceeds while the monomer gathers in the bright portions of interference fringes that are formed by hologram exposure and the matrix gathers in the dark portions, thereby forming an amount of refractive index modulation. A structure formed as described above is referred to as a diffraction grating.

The present inventors considered that, in order to realize additional improvement in the amount of refractive index modulation, it is necessary to form a diffraction grating in which the material separation properties of a monomer and a matrix which have different refractive indexes are strong.

In addition, the present inventors considered that, in addition to the material separation properties, when a material density difference is caused between the bright portions and the dark portions of interference fringes, improvement in the amount of refractive index modulation derived from the density can also be expected.

However, in the related art, it has not yet been confirmed how the distributions of the monomer and the matrix, the distribution of densities or the like in accordance with interference fringes is formed. A possible reason therefor Is that the monomer and the matrix are often organic substances and are composed of similar elements and thus cannot be differentiated in spite of an attempt of observation with, for example, a scanning electron microscope, a transmission electron microscope or the like.

For example, there has been a proposal of a method in which Os is added only to a material having a double bond by a chemical reaction using a stain such as OsO4 and a microphase-separated structure in photochromic crystals is observed as in NPL 1. However, this method is applicable only to materials that are reactive to Os, requires appropriate conditions for a staining treatment to be found, and cannot be said to be an appropriate technique for observing the distributions of all hologram materials.

Additionally, in NPL 2, the film surface of a hologram recording material is observed with an atomic force microscope (AFM), and crests and troughs formed by exposure are observed. However, this is simply the observation of crests and troughs on the film surface, and the distribution of material densities formed in a film cannot be evaluated.

As described above, in the related art, there has been no means for evaluating hologram recording films having further-improved diffraction characteristics, which has made it impossible to provide a composition for hologram recording, a hologram recording medium, a hologram and the like that have superior diffraction characteristics.

Incidentally, the present inventors were able to find a hologram recording film having not only the material separation properties of a monomer and a matrix in the bright portions and the dark portions of interference fringes but also a diffraction grating having a high material density difference as the internal structure of the film using the atomic force microscopy (AFM). As described above, the use of the atomic force microscopy (AFM) made it possible to propose a composition for hologram recording, a hologram recording medium, a hologram and the like that had improved diffraction characteristics (preferably the amount of refractive index modulation Δn or the clarity of the diffraction grating structure)

Specifically, as a result of intensive studies, the present inventors found that, when a film cross section of a hologram is measured with AFM and a periodic structure corresponding a diffraction grating can be observed in an image reflecting mechanical properties such as a shape image, a phase image, an error signal image or an elastic modulus image, the material density distribution and the material separation properties in a film are favorable, and a hologram recording film having improved diffraction characteristics is formed.

This periodic structure can be more clearly observed when a difference in material properties between the bright portions and the dark portions of interference fringes and a difference in the material density are strongly caused. The shape image is an image showing crests and troughs on the surface, but also has an influence on the hardness or mechanical properties of materials, and thus a periodic structure similar to the phase image or images reflecting the other mechanical properties can be observed.

From the above-described facts, the present inventors found that a hologram recording film having excellent diffraction characteristics can be prepared by the atomic force microscopy (AFM). Furthermore, the present inventors found that it is preferable to use the position of a periodic structure-derived peak, the amount of refractive index modulation and the clarity when the cross-sectional observation image has been Fourier-transformed. In addition, the present inventors found a composition for hologram recording in which a cross-sectional observation image at the time of observing a hologram recording film by the atomic force microscopy (AFM) has a diffraction grating structure indicating that there is a material density difference that can be observed by the AFM. The present inventors found that, according to this composition, a hologram recording film having excellent diffraction characteristics and a hologram containing this hologram recording film are possible.

Therefore, the present disclosure is capable of providing a composition for hologram recording, a hologram recording medium and a hologram that are capable of realizing excellent diffraction characteristics and an optical device and an optical member using same.

### 2. First Embodiment (Composition for Hologram Recording)

A first embodiment according to the present technique is capable of providing a composition for hologram recording containing at least a radical polymerizable monomer and a matrix resin, in which a cross-sectional observation image at the time of observing a hologram recording film by the atomic force microscopy (AFM) has a diffraction grating structure indicating that there is a material density difference that can be observed by the AFM.

### <2-1. Characteristics of Diffraction Grating Structure of Composition for Hologram Recording>

The composition for hologram recording of the present embodiment is preferably a configuration capable of forming a hologram recording film having a diffraction grating structure indicating that there is a material density difference that can be observed by AFM.

Furthermore, the composition for hologram recording of the present embodiment is preferably a configuration capable of forming a hologram recording film in which, when the cross-sectional observation image has been Fourier-transformed, a periodic structure-derived peak can be observed at a wavenumber position with a different origin of a power spectrum.

In the present specification, “the composition for hologram recording of the present embodiment” will also be referred to as “the composition of the present embodiment”.

In the present embodiment, “material density difference” means a density difference caused by the fact that a portion derived from photoreaction-induced phase separation and polymerized by a photoreaction has a high density and a portion where phase separation is not induced has a low density.

In the present embodiment, regarding whether or not the diffraction grating structure of a hologram recording film is periodic (stripe patterns), in a case where peaks symmetrical to the origin (hereinafter, also referred to as “origin symmetrical”) are observed in an image obtained by the two-dimensional Fourier transformation of the diffraction grating structure, the diffraction grating structure can be evaluated as “periodic (stripe patterns)”. In addition, in a case where origin-symmetrical peaks are not observed, the diffraction grating structure can be evaluated as “not periodic (stripe patterns)”.

In addition, in the present embodiment, the image reflecting mechanical properties from which a periodic structure can be observed is not particularly limited, examples thereof include a shape image, a phase image, an error signal image, an elastic modulus image and the like, and one or two or more selected from those can be used.

Here, ordinarily, as the measurement mode of atomic force microscopes, there are a contact mode and a tapping mode. In the contact mode, an in-depth probe and a specimen are brought into contact with each other, and the specimen surface is scanned while the deflection of a cantilever is controlled to become uniform, thereby obtaining a crest and trough image of the specimen surface. An image obtained as described above is referred to as “shape image”.

At the time of scanning the specimen surface, since the phase of the cantilever also changes due to the interaction between the in-depth probe and the specimen, the phase obtained as an image is referred to as “phase image”. Since the phase change is mainly caused due to mechanical properties such as the elasticity or viscosity of the specimen and the adsorption between the specimen and the in-depth probe, the phase image becomes an image reflecting the mechanical properties of the specimen.

In addition, an image showing a change in the amplitude of the cantilever is the “error signal image”, and an image in which the shape image appears to have been differentiated is obtained. Edges of crests and troughs are distinctively observed.

In addition, as a measurement method for more quantitatively obtaining the distribution of the mechanical properties of the specimen, there is a method in which the elastic modulus is calculated using a measurement mode called force curve (NPL 4 (reference literature): KENBIKYO Vol. 44, No. 2 (2009) 145 to 149, Ken Nakajima et al. “Recent Research and Technology, AFM Characterization for Mechanical Properties of Polymeric Materials”). The force curve is a mode where the mechanical properties are measured at one point, but the elastic modulus can be obtained in a two-dimensional manner by measuring the force curve in a two-dimensional manner, and this is called “elastic modulus image”.

Furthermore, the composition of the present embodiment is more preferably a configuration in which the periodic structure-derived peak can be formed to be predetermined times or more higher than the noise waveform of the baseline.

The periodic structure-derived peak is more preferably two or more times and still more preferably three or more times higher than the noise waveform of the baseline.

In a case where there is a plurality of peaks or a peak is broad, whether or not a peak derived from a periodic structure is observed may be determined by selecting all of the peaks that are predetermined times (more preferably three or more times) higher than the noise waveform of the baseline.

The composition of the present embodiment is preferably a configuration in which the amount of refractive index modulation Δn can be formed to be a predetermined value or more since the diffraction characteristics become superior. The amount of refractive index modulation Δn is preferably 0.04 or more, more preferably 0.05 or more and still more preferably 0.06 or more. The upper limit value of the amount of refractive index modulation Δn is not particularly limited and is, for example, approximately 0.1 or 0.2.

The composition of the present embodiment is preferably a configuration in which the clarity of the diffraction grating structure can be favorably formed since the diffraction characteristics become superior.

In the present embodiment, in the diffraction grating structure portion in the shape image of the cross-sectional observation image, a region is divided such that there is at least one section where at least crests and troughs of the periodic structure are included, and the mode of the standard deviation values of the divided regions (local region standard deviations) is defined as the clarity of the diffraction grating structure.

In a case where the local region standard deviations are calculated in a region including the protective film and hologram film portion (crest and trough portion), the region is divided as described above, and these local region standard deviations are made into a histogram. When two or more peaks (X0, X1, X2, . . . ) are observed in this histogram, the mode of the peak farthest from X0 (X zero) is defined as the “clarity”. When the number of peaks is less than two, since it is regarded that there is no large difference in crests and troughs in the protective film and hologram film portion, the clarity becomes incalculable.

A more specific method for obtaining the clarity will be described in <Method for evaluating diffraction characteristics of hologram by atomic force electron microscopy (AFM)> and [Examples].

The crests and troughs of the periodic structure are preferably crests and troughs having a height difference of 2 nm or more, which will be described below.

The shape of the division is not particularly limited, but is preferably a quadrangular shape (a rectangular shape, a square shape, a trapezoidal shape or the like), preferably a shape in which a set region can be divided in predetermined area fractions and more preferably a square shape. The size of one side of the shape is preferably approximately 100 to 400 nm (±10 nm), more preferably approximately 200 nm (±10 nm) and still more preferably approximately 200 nm (±5 nm). Each section may partially overlap an adjacent section.

The clarity is more preferably 2 nm or more, still more preferably 2.5 nm or more, far still more preferably 3 nm or more, more preferably 3.5 nm or more, more preferably 4 nm or more, more preferably 4.5 nm or more and more preferably 5 nm or more.

The clarity can be obtained based on the mode apart from 0 nm.

### <Method for Evaluating Diffraction Characteristics of Hologram by Atomic Force Electron Microscopy (AFM)>

The diffraction characteristics of the hologram recording film can be evaluated by the atomic force electron microscopy (AFM) in an order shown in FIG. 2 and the following S01 to S09.

The diffraction characteristics of the hologram recording film were evaluated in an order of a treatment of a hologram (S01 to S05), observation by the atomic force electron microscopy (AFM) (S06), confirmation of the presence of a peak derived from a periodic structure (S07 to S08) and confirmation of the clarity of the diffraction grating structure (S09).

### <Treatment of Hologram (S01 to S05)>

S01: As a pretreatment specimen for AFM observation, the hologram 20 including the transparent protective film 21, the hologram recording film 22 and the transparent protective film 21 is prepared. FIG. 2A is a schematic view of the hologram 20 having both surfaces sandwiched by the transparent protective films 21 and 21. The hologram 20 is produced by carrying out a treatment such as exposure on a hologram recording medium.

S02: The hologram 20 is embedded in an embedding resin 31. At this time, the hologram 20 is embedded to be perpendicular to the end surface (cut surface) of the embedding resin 31 (for example, refer to FIG. 2B). At the time of this adjustment, an embedding mold having a desired shape (for example, a trapezoidal mold or the like) may be used. As the embedding resin 31, an epoxy resin (for example, two-component mixed epoxy resin: BOND QUICK 5 manufactured by Konishi Co., Ltd.) is preferably used.

This embedding resin method makes cross-sectional processing possible even in a case where the hologram recording film is a thin or soft and non-standable film. In a case where the hologram recording film is a sufficiently thick or hard and standable film, the embedding resin method may be skipped.

S03: A holder for cross section cutting 32 is installed in each embedding resin 31 in which the hologram 20 has been embedded (for example, refer to FIG. 2C). As shown in FIG. 2C, at the time of installation, a cut surface and a hologram are desirably disposed so as to be orthogonal to each other.

S04: The excess embedding resin 31 is trimmed with a knife 33 (for example, a glass knife) such that the cut surface of the hologram 20 becomes small. As the trimming, for example, the hologram 20 may be cut obliquely along oblique broken lines in S04. The projecting portions of the hologram recording film 20 projecting from the embedding resin 31 are preferably made into a trapezoidal shape by this oblique cutting.

S05: Finish cutting of the cut surface of the hologram 20 is carried out with the knife 33 (for example, a diamond knife). The direction of the finish cutting is desirably a direction perpendicular to the thickness in order to suppress cutting sagging or deformation of the internal structure of the film. For example, the finish cutting is carried out in a broken line direction in S05 such that the longitudinal direction of the hologram and the cut surface become perpendicular to each other (for example, refer to FIG. 2D).

### <Observation by Atomic Force Electron Microscopy (AFM) (S06)>

S06: E1 in FIG. 2 indicates a state where the hologram 20 having the cut surface prepared in S05 and an embedding resin 32 are supported by the holder 32 for cross section cutting and is a schematic view of this state seen from a side. E2 in FIG. 2 is a schematic view of the cut surface of the hologram 20 from above (reference sign 34).

The cut surface of the hologram recording film 20 is measured by the AFM in a state where the hologram recording film 20 is supported by the holder for cross section cutting 32. The cut surface is preferably measured in a tapping measurement mode, but may be measured in a force volume mode, a peak force tapping mode or the like.

For example, as an AFM measuring instrument, E-sweep and Nano Navi manufactured by Seiko Instruments Inc., which will be described below, a measuring instrument in this category or a successor measuring instrument can be used, and the AFM measurement can be carried out under condition setting to be described below.

<Confirmation of Presence of Peak Derived from Periodic Structure (S07 to S08)>

S07: Whether or not a diffraction grating structure (for example, stripe patterns) is observed in the hologram recording film 22 portion is confirmed in a cross-sectional observation image (for example, a shape image, a phase image, an error signal image, an elastic modulus image or the like) by the AFM. Among these, the confirmation is preferably carried out with a shape image.

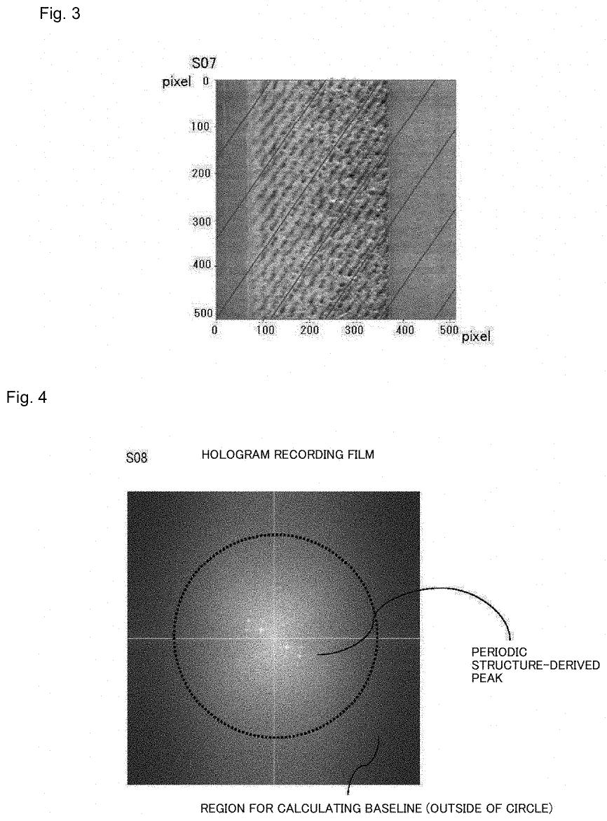

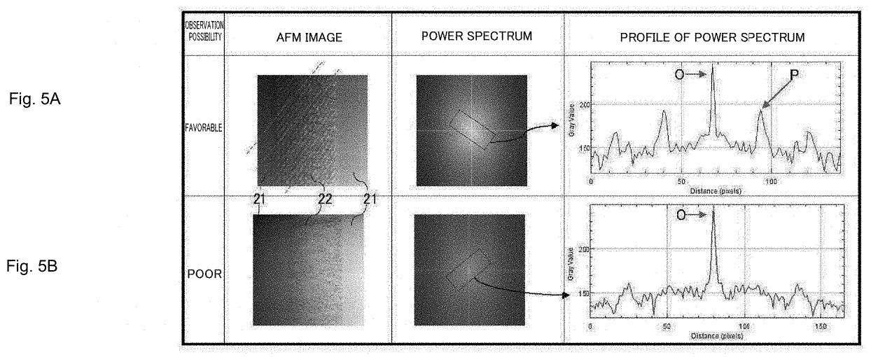

A cross-sectional observation image (shape image) by the AFM in FIG. 3 is an example of hologram cross-sectional observation in which a diffraction grating structure (stripe patterns) has been observed.

S08: In a case where it has been observed that the diffraction grating structure is periodic (stripe patterns), furthermore, regarding the presence or absence of a peak, whether or not a peak derived from the periodic structure is present can be confirmed in a power spectrum (power spectrum) obtained by two-dimensional Fourier transformation of the cross-sectional observation image (refer to FIG. 4). More accurate determination can be obtained by carrying out S08 without skipping S07. With S07 and S08, it is possible to determine whether or not the diffraction grating structure is periodic (stripe patterns) with objectively higher accuracy.

The two-dimensional Fourier transformation can be carried out with image processing software such as ImageJ. As the lowest frequency component at the center of the power spectrum obtained at this time becomes more distant from the center, a peak derived from a higher frequency component is observed. When the baseline is standard deviations in portions excluding a range having an origin at the center and a diameter of 80% of the image width, if peaks of three or more times of the baseline are observed to be origin-symmetrical, it is possible to determine that a peak derived from the periodic structure is more preferably observed. In the case of peaks of two or more times of the baseline, it is possible to determined that a peak is preferably observed; however, in the [examples] to be described below, determination was made with “peaks of three or more times of the baseline” in order for more preferable observation.

### <S09: Confirmation of Clarity of Diffraction Grating Structure>

S09: The mode of the standard deviation value in a region divided in a section where the crests and troughs of the periodic structure are included (local region standard deviation) in the diffraction grating structure portion in the shape image of the cross-sectional observation image is defined as the “clarity” of the diffraction grating structure. As the clarity increases, it is possible to evaluate that the diffraction characteristics are superior. Specifically, when the clarity is two or more, it is possible to determine that “the diffraction characteristics are excellent”, and, when the clarity is four or more, it is possible to determine that “the diffraction characteristics are extremely excellent”.

### <2-2. Components of Composition for Hologram Recording>

Hereinafter, individual components, individual blending amounts and the like of the composition for hologram recording of the present embodiment will be described, but the present technique is not limited to this.

The composition of the present embodiment contains at least a radical polymerizable monomer and a matrix resin, and it is preferable to adjust a variety of components, individual blending amounts or the like so as to form a configuration as in the above-described <2-1.>.

In the composition of the present embodiment, the radical polymerizable monomer is preferably a plurality of radical polymerizable monomers having different refractive indexes.

In addition, in the composition of the present embodiment, furthermore, an anthracene-based compound is preferably used.

In addition, according to the composition of the present embodiment, it is possible to obtain a hologram recording film and a hologram which have excellent diffraction characteristics without undergoing a heating step after exposure. In addition, according to the composition for hologram recording, it is possible to make the transparency of a hologram recording film favorable.

Hereinafter, individual components that are used in the composition for hologram recording of the present embodiment will be described in detail, but the present technique is not limited to this.

### [2-2-1. Radical Polymerizable Monomer]

The composition for hologram recording of the present embodiment contains a radical polymerizable monomer. As the radical polymerizable monomer of the present embodiment, at least two radical polymerizable monomers are preferably contained, and furthermore, a monofunctional monomer and a polyfunctional monomer are more preferably contained.

From the viewpoint of improving the diffraction characteristics of a hologram to be obtained, the refractive index of the radical polymerizable monomer is preferably 1.5 or more and more preferably 1.6 or more. The upper limit value is not particularly limited and can be considered to be, for example, a refractive index of 2.0 or less in consideration of the development status of high-refractive index organic compounds, but is not limited thereto. The refractive index can be measured by a critical angle method or a spectroscopic ellipsometry method.

For example, in the critical angle method, the refractive index can be measured using an Abbe refractometer ER-1 manufactured by Erma Inc. (as the measurement wavelengths, the refractive index is measured using 486 nm, 589 nm, 656 nm and the like in the visible light region).

As the radical polymerizable monomer, one or two or more selected from a carbazole-based monomer, a fluorene-based monomer, a dinaphthothiophene-based monomer are preferably used.

As a preferable aspect, the composition of the present embodiment contains at least a monofunctional carbazole-based monomer and a polyfunctional fluorene-based monomer. In addition, the polyfunctional fluorene-based monomer is preferably a difunctional fluorene-based monomer.

In the present embodiment, the monofunctional carbazole-based monomer is preferably a compound represented by the following general formula (1).

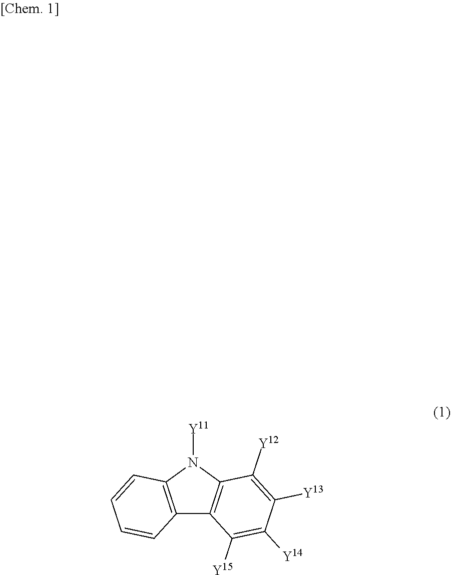

In the general formula (1), only any one of Y¹¹ to Y¹⁵ is any one of substituents represented by the following general formulae (2-1) to (2-7). In a case where any two or more of Y¹¹ to Y¹⁵ are any two or more of substituents represented by the following general formulae (2-1) to (2-7), the compound becomes a polyfunctional (di- or higher functional) carbazole-based monomer.

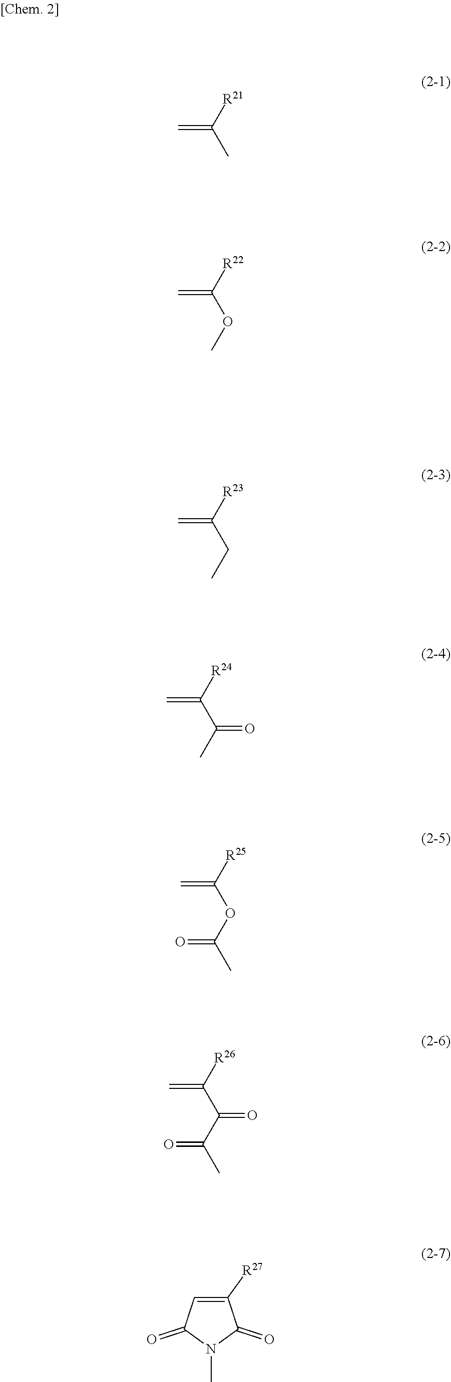

As each of Y¹¹ to Y¹⁵ (here, at least one of Y¹¹ to Y¹⁵ that becomes at least one of the substituents represented by the general formulae (2-1) to (2-7) is excluded), and R²¹ to R²⁷, for example, each group such as an alkyl group (a methyl group, an ethyl group, a propyl group, an isopropyl group, a t-butyl group, a pentyl group, a hexyl group, an octyl group, a dodecyl group, a trifluoromethyl group or the like); a cycloalkyl group (a cyclopentyl group, a cyclohexyl group or the like); an aryl group (a phenyl group, a naphthyl group or the like); an acylamino group (an acetylamino group, a benzoylamino group or the like); an alkylthio group (a methylthio group, an ethylthio group or the like); an arylthio group (a phenylthio group, a naphthylthio group or the like); an alkenyl group (a vinyl group, a 2-propenyl group, a 3-butenyl group, a 1-methyl-3-propenyl group, a 3-pentenyl group, a 1-methyl-3-butenyl group, a 4-hexenyl group, a cyclohexenyl group or the like); a halogen atom (a fluorine atom, a chlorine atom, a bromine atom, an iodine atom or the like); an alkynyl group (a propargyl group or the like); a heterocyclic group (a pyridyl group, a thiazolyl group, an oxazolyl group, an imidazolyl group or the like); an alkylsulfonyl group (a methylsulfonyl group, an ethylsulfonyl group or the like); an arylsulfonyl group (a phenylsulfonyl group, a naphthylsulfonyl group or the like); an alkylsulfinyl group (a methylsulfinyl group or the like); an arylsulfinyl group (a phenylsulfinyl group or the like); a phosphono group; an acyl group (an acetyl group, a pivaloyl group, a benzoyl group or the like); a carbamoyl group (an aminocarbonyl group, a methylaminocarbonyl group, a dimethylaminocarbonyl group, a butylaminocarbonyl group, a cyclohexylaminocarbonyl group, a phenylaminocarbonyl group, a 2-pyridylaminocarbonyl group or the like); a sulfamoyl group (an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenyl aminosulfonyl group, a naphthylaminosulfonyl group, a 2-pyridylaminosulfonyl group or the like); sulfonamide groups (a methanesulfonamide group, a benzenesulfonamide group and the like); cyano groups; alkoxy groups (a methoxy group, an ethoxy group, a propoxy group and the like); aryloxy groups (a phenoxy group, a naphthyloxy group and the like); heterocyclic oxy groups; siloxy groups; acyloxy groups (an acetyloxy group, a benzoyloxy group and the like); sulfonic acid groups; salts of sulfonic acid; aminocarbonyloxy groups; amino groups (an amino group, an ethylamino group, a dimethylamino group, a butylamino group, a cyclopentylamino group, a 2-ethylhexylamino group, a dodecylamino group and the like); anilino groups (a phenylamino group, a chlorophenylamino group, a toluidino group, an anisidino group, naphthylamino group, 2-pyridylamino group and the like); imide groups; ureido groups (a methylureido group, an ethylureido group, a pentylureido group, a cyclohexylureido group, an octylureido group, a dodecylureido group, a phenylureido group, a naphthylureido group, a 2-pyridyl amino ureido group and the like); alkoxycarbonylamino groups (a methoxycarbonylamino group, a phenoxycarbonylamino group and the like); alkoxycarbonyl groups (a methoxycarbonyl group, an ethoxycarbonyl group, phenoxycarbonyl and the like); aryloxycarbonyl groups (a phenoxycarbonyl group and the like); heterocyclic thio groups; thioureid groups; carboxyl groups; carboxylic acid salts; hydroxyl groups; mercapto groups; and nitro groups can be independently exemplified, but Y¹¹ to Y¹⁵ and R²¹ to R²⁷, are not limited thereto. In addition, each of these groups may have a substituent, and examples of the substituent include the same groups as the groups described above. In addition, one or two or more may be selected from the group consisting of these.

The monofunctional carbazole-based monomer represented by the general formula (1) can be synthesized by a variety of well-known synthesis methods and can be synthesized based on, for example, the synthesis method described in JP 2015-105239 A.

In the present embodiment, among the carbazole-based monomers represented by the general formula (1), carbazole acrylate and/or N-vinyl carbazole derivative is preferably used. For example, 2-(9H-carbazol-9-yl)ethyl acrylate (manufactured by Sigma-Aldrich Co. LLC, refractive index: 1.65) or N-vinylcarbazole (manufactured by Tokyo Chemical Industry Co., Ltd., refractive index: 1.68) is preferably used.

In the present embodiment, the difunctional fluorene-based monomer (polyfunctional fluorene-based monomer) is preferably 9,9-bisarylfluorenes, and a compound represented by the following general formula (3) can be exemplified.

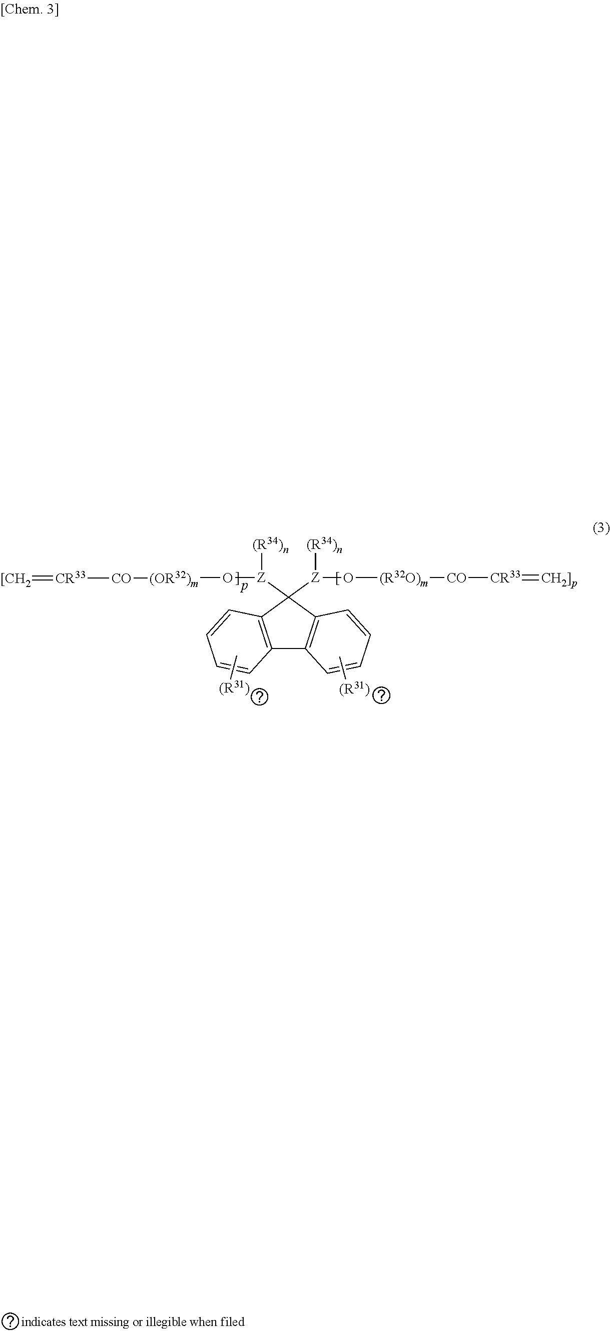

In the general formula (3), a ring Z is an aromatic hydrocarbon ring, R³¹ represents a substituent, R³² represents an alkylene group, R³³ represents a hydrogen atom or a methyl group, R³⁴ represents a substituent, k is an integer of 0 to 4, m is an integer of 0 or more, n is an integer of 0 or more and p is an integer of 1. In a case where p is 2 or more, the compound is a polyfunctional fluorene-based monomer.

In the general formula (3), as the aromatic hydrocarbon ring represented by the ring Z, for example, a benzene ring, a fused polycyclic arene (or fused polycyclic aromatic hydrocarbon) ring and the like can be exemplified. Among these, examples of the fused polycyclic arene (or fused polycyclic aromatic hydrocarbon) ring include fused bi- to tetracyclic arene rings such as fused bicyclic arene rings (C₈₋₂₀ fused bicyclic arene rings such as an indene ring and a naphthalene ring, preferably C₁₀₋₁₆ fused bicyclic arene rings) and fused tricyclic arene rings (an anthracene ring, a phenanthrene ring and the like) and the like. Examples of preferable fused polycyclic arene rings include a naphthalene ring, an anthracene ring and the like, and one or two or more may be selected from the group consisting of these. Among these, a naphthalene ring is more preferable.

The two rings Z in the general formula (3) may be the same or different rings and, usually, may be the same rings.

In the general formula (3), a typical ring Z is a benzene ring or a naphthalene ring, and the ring Z may be a naphthalene ring from the viewpoint of the high heat resistance, high refractive index and the like of holograms.

In the general formula (3), as the group R³¹, unreactive substituents such as a cyano group; a halogen atom (a fluorine atom, a chlorine atom, a bromine atom or the like); a hydrocarbon group [an alkyl group, an aryl group (a C₆₋₁₀ aryl group such as a phenyl group) or the like]; and the like can be exemplified, and a group that is not a halogen atom such as an alkyl group is preferable. As the alkyl group, C₁₋₁₂ alkyl groups such as a methyl group, an ethyl group, a propyl group, an isopropyl group, a butyl group and a t-butyl group (for example, C₁₋₈ alkyl groups, particularly, C₁₋₄ alkyl groups such as a methyl group) and the like can be exemplified, and one or two or more may be selected from the group consisting of these.

In a case where k in the formula (3) is plural (2 or more), R³¹'s may be identical to or different from each other.

In addition, in the general formula (3), the groups R³¹ substituting the two benzene rings that configure fluorene (or the fluorene skeleton) may be identical to or different from each other.

In addition, in the general formula (3), the binding positions (substitution sites) of the groups R³¹ with respect to the benzene rings that configure fluorene are not particularly limited.

In the general formula (3), the number of substitutions k is preferably 0 or 1 and more preferably 0.

In the general formula (3), in the two benzene rings that configure fluorene, the numbers of substitutions k may be identical to or different from each other.

In the general formula (3), examples of the alkylene group represented by the group R³² include C₂₋₆ alkylene groups such as an ethylene group, a propylene group, a trimethylene group, a 1,2-butanediyl group and a tetramethylene group and the like. The alkylene group represented by the group R³² is preferably a C₂₋₄ alkylene group and more preferably a C₂₋₃ alkylene group. One or two or more may be selected from the group consisting of these.

When m in the general formula (3) is 2 or more, the alkylene groups may be different alkylene groups and, usually, may be identical alkylene groups. In addition, in the two rings Z, the groups R³² may be identical to or different from each other and, usually, may be identical to each other.

The number (the number of moles added) m of oxyalkylene groups (OR³²) in the general formula (3) is not particularly limited, can be selected from a range of approximately 0 to 15 (for example, 0 to 12) and may be, for example, 0 to 8 (for example, 1 to 8), preferably 0 to 6 (for example, 1 to 6) and more preferably 0 to 4 (for example, 1 to 4). m may be preferably 1 or more (for example, 1 to 4, preferably 1 to 3, more preferably 1 or 2 and still more preferably 1). The numbers of substitutions m may be identical to or different from each other in different rings Z.

Additionally, in the general formula (3), the total (m×2) of the oxyalkylene groups in the two rings Z is not particularly limited, can be selected from a range of approximately 0 to 30 (for example, 2 to 24) and may be, for example, 0 to 16 (for example, 2 to 14), preferably 0 to 12 (for example, 2 to 10), more preferably 0 to 8 (for example, 0 to 6) and still more preferably 0 to 4 (for example, 2 to 4).

In the general formula (3), the number of substitutions p of a group including the group R³² (referred to as a (meth)acryloyl group-containing group or the like in some cases) is 1, but becomes 2 or more in the case of the polyfunctional fluorene-based monomer. The number of substitutions p may be identical to or different from each other in the individual rings Z, but are, usually, identical to each other in many cases.

In addition, in the general formula (3), the substitution site of the (meth)acryloyl group-containing group is not particularly limited, and the (meth)acryloyl group-containing group may substitute an appropriate substitution site of the ring Z. For example, when the ring Z is a benzene ring, the (meth)acryloyl group-containing group may substitute an appropriate position (preferably at least the position 4) of the positions 2 to 6 of the benzene ring, and, when the ring Z is a fused polycyclic hydrocarbon ring, the (meth)acryloyl group-containing group may substitute at least a hydrocarbon ring different from a hydrocarbon ring bonding to the position 9 of fluorene (for example, the position 5, position 6 or the like of a naphthalene ring).

In the general formula (3), as the substituent R³⁴ that substitutes the ring Z, usually, unreactive substituents, for example, alkyl groups (C₁₋₁₂ alkyl groups such as a methyl group, an ethyl group, a propyl group, an isopropyl group and a butyl group, preferably C₁₋₈ alkyl groups and more preferably C₁₋₆ alkyl groups and the like); cycloalkyl groups (C₅₋₈ cycloalkyl groups such as a cyclohexyl group and preferably C₅₋₆ cycloalkyl groups and the like); aryl groups (C₆₋₁₄ aryl groups such as a phenyl group, a tolyl group, a xylyl group and a naphthyl group, preferably C₆₋₁₀ aryl groups and more preferably C₆₋₈ aryl groups and the like); hydrocarbon groups such as aralkyl groups (C₆₋₁₀ aryl to C₁₋₄ alkyl groups such as a benzyl group and a phenethyl group and the like); group-OR³⁵ [in the formula, R³⁵ represents a hydrocarbon group (the hydrocarbon group exemplified above)] such as alkoxy groups (C₁₋₈ alkoxy groups such as a methoxy group and an ethoxy group and preferably C₁₋₆ alkoxy groups and the like), cycloalkoxy groups (C₅₋₁₀ cycloalkyloxy groups such as a cyclohexyloxy group and the like), aryloxy groups (C₆₋₁₀ aryloxy groups such as a phenoxy group and the like), aralkyloxy groups (C₆₋₁₀ aryl to C₁₋₄ alkyloxy groups such as a benzyloxy group and the like); group-SR³⁵ (in the formula, R³⁵ is the same as above) such as alkylthio groups (C₁₋₈ alkylthio groups such as a methylthio group and an ethylthio group and preferably C₁₋₆ alkylthio groups and the like), cycloalkylthio groups (C₅₋₁₀ cycloalkylthio groups such as a cyclohexylthio group), arylthio groups (C₆₋₁₀ arylthio groups such as a thiophenoxy group), aralkylthio groups (C₆₋₁₀ aryl to C₁₋₄ alkylthio groups such as a benzylthio group and the like); acyl groups (C₁₋₆ acyl groups such as an acetyl group and the like); alkoxycarbonyl groups (C₁₋₄ alkoxy-carbonyl groups such as a methoxycarbonyl group); halogen atoms (a fluorine atom, a chlorine atom, a bromine atom, an iodine atom and the like); nitro groups; cyano groups; substituted amino groups (dialkylamino groups such as a dimethylamino group); and the like. One or two or more may be selected from the group consisting of these.

In the general formula (3), examples of preferable R³⁴ include hydrocarbon groups [alkyl groups (for example, C₁₋₆ alkyl groups and the like), cycloalkyl groups (for example, C₅₋₈ cycloalkyl groups and the like), aryl groups (for example, C₆₋₁₀ aryl groups and the like), aralkyl groups (for example, C₆₋₈ aryl to C1-2 alkyl groups) and the like], alkoxy groups (for example, C₁₋₄ alkoxy groups and the like) and the like. One or two or more may be selected from the group consisting of these.

Among these, alkyl groups [C₁₋₄ alkyl groups (preferably a methyl group) and the like], aryl groups [C₆₋₁₀ aryl groups (preferably a phenyl group) and the like] and the like are more preferable.

In the general formula (3), in a case where n is plural (2 or more) in the same ring Z, R³⁴'s may be identical to or different from each other. In addition, in the two rings Z, the groups R³⁴ may be identical to or different from each other. In addition, in the general formula (3), a preferable number of substitutions n can be selected depending on the type of the ring Z and may be, for example, 0 to 8, preferably 0 to 4 (for example, 0 to 3) and more preferably 0 to 2. In the general formula (3), in different rings Z, the numbers of substitutions n may be identical to or different from each other and, usually, may be identical to each other.

The difunctional fluorene-based monomer (polyfunctional fluorene-based monomer) represented by the general formula (3) can be synthesized by a variety of well-known synthesis methods and can be synthesized based on, for example, the synthesis method described in JP 2012-111942 A.

In the present embodiment, as the fluorene-based monomer represented by the general formula (3), for example, bisphenoxyethanolfluorene diacrylate (manufactured by Osaka Gas Chemicals Co., Ltd., “EA-0200”, refractive index: 1.62) is preferably used.

The composition for hologram recording of the present embodiment contains, as a preferable aspect, at least a monofunctional dinaphtothiophene-based monomer and a polyfunctional fluorene-based monomer. In addition, the polyfunctional fluorene-based monomer is preferably a difunctional fluorene-based monomer.

The monofunctional dinaphtothiophene-based monomer is preferably a compound represented by the following general formula (4).

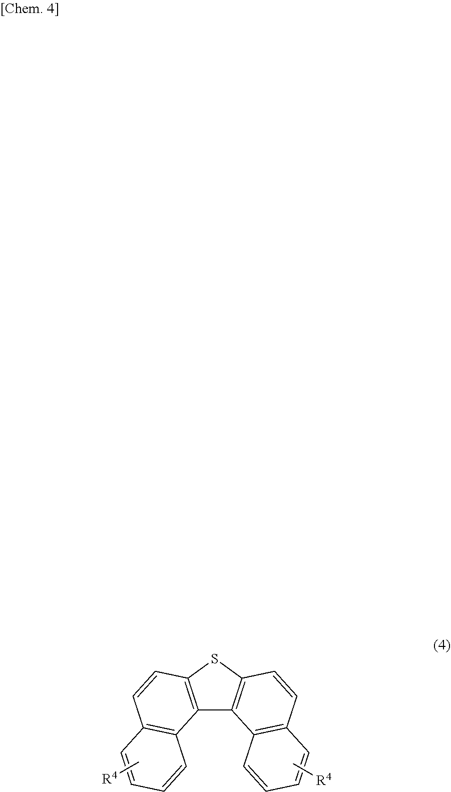

In the general formula (4), R⁴ is a substituent on a benzene ring that is not fused with a thiophene ring and is a hydroxyl group, a 2-allyloxy group, a vinyloxy group, a 2,3-epoxypropoxy group, a 2-(meth)acryloyloxy group, a 2-(meth)acryloyloxyethoxy group, R⁴¹O-group (in the formula, R⁴¹ represents an alkyl group that may include oxygen or sulfur as a heteroatom) or HO—X—O-group (in the formula, X represents an alkylene chain or aralkylene chain that may include oxygen or sulfur as a heteroatom).

In the case of the monofunctional dinaphtothiophene-based monomer, any one R⁴ of the two R⁴'s in the general formula (4) is preferably a group having a polymerizable unsaturated bond, and, in the case of the difunctional dinaphtothiophene-based monomer, the two R⁴'s in the general formula (4) are preferably groups having a polymerizable unsaturated bond.

In the general formula (4), R⁴¹ is an alkyl group that may include oxygen or sulfur as a heteroatom. As R⁴¹, linear or branched alkyl groups having 1 to 20 carbon atoms can be exemplified. Examples of the alkyl group include a methyl group, an ethyl group, a propyl group, an isopropyl group, an n-butyl group, an isobutyl group, a sec-butyl group, a tert-butyl group, a 2-ethylhexyl group, a dodecyl group, a cetyl group, a methoxymethyl group, a 2-methoxyethyl group, an ethoxymethyl group, a 2-(ethoxy)ethyl group, a 2-(methyl mercapto)ethyl group and the like. One or two or more may be selected from the group consisting of these.

In addition, in the general formula (4), X is an alkylenen chain or aralkylene chain that may include oxygen or sulfur as a heteroatom. As the alkylenen chain, linear or branched alkylenen chains having 1 to 10 carbon atoms can be exemplified. Examples of the alkylenen chain include a methylene group, an ethylene group, a trimethylene group, a tetramethylene group, a hexamethylene group, a decamethylene group, a propylene group, a cyclohexylene group and the like. As the alkylene chain that may include a heteroatom of oxygen or sulfur, polyoxyalkylene chains containing oxyethylene or oxypropylene as a repeating unit can be exemplified. One or two or more may be selected from the group consisting of these.

In the general formula (4), examples of an alkylene portion of the aralkylene chain that may include a heteroatom of oxygen or sulfur include the above-described alkylene chain.

The dinaphthothiophene-based monomer represented by the general formula (4) can be synthesized by a variety of well-known synthesis methods and can be synthesized based on, for example, the synthesis method described in JP 2014-196288 A.

In the present embodiment, as the dinaphthothiophene-based monomer represented by the general formula (4), for example, dinaphthothiophene methacrylate (manufactured by Sugai Chemical Industry Co., Ltd., “DNTMA”, refractive index: 1.89) is preferably used.

The composition for hologram recording of the present embodiment contains, as another preferable aspect, at least a monofunctional and polyfunctional acrylate or methacrylate and inorganic fine particles to be described below. In a case where the composition for hologram recording contains inorganic fine particles, a radical polymerizable monomer having a low refractive index is preferably used.

As the monofunctional acrylate, for example, alkyl acrylates (lauryl acrylates, tetradecyl acrylate, stearyl acrylate, isostearyl acrylate, behenyl acrylate and the like); isoboronyl acrylate; methoxypolyethylene glycol acrylate; methoxypolypropylene glycol acrylate; benzene ring-containing acrylates (phenoxyethylene glycol acrylate, phenoxydiethylene glycol acrylate and the like) and the like can be exemplified, and one or two or more may be selected from the group consisting of these.

In addition, as the monofunctional methacrylate, methacrylates of the above-described compounds and the like can be exemplified, and one or two or more may be selected from the group consisting of these.

Incidentally, as the polyfunctional acrylate, for example, alkyl diacrylates (1,6-hexanediol diacrylate, 1,9-nonanediol diacrylate, isononanediol diacrylate, 1,10-decanediol diacrylate, neopentyl glycol diacrylate and the like); polyethylene glycol diacrylate; dipropropylene glycol diacrylate; tripropylene glycol diacrylate; polytetramethylene glycol diacrylate; and the like can be exemplified, and one or two or more may be selected from the group consisting of these.

In addition, as the polyfunctional methacrylate, methacrylates of the above-described compounds and the like can be exemplified, and one or two or more may be selected from the group consisting of these.

Among these compounds, from the viewpoint of the combination with the inorganic fine particles, the refractive index of the compound is preferably not high, and a monomer not having an aromatic structure such as a benzene ring is preferably used. More specifically, a (saturated) alkyl or a monomer having a (saturated) alicyclic hydrocarbon structure is preferably used.

### [2-2-2. Matrix Resin]

The matrix resin that is contained in the composition for hologram recording of the present embodiment is not particularly limited, and an arbitrary matrix resin can be used.

Examples of the matrix resin include vinyl acetate-based resins such as polyvinyl acetate and hydrolyzates thereof; acrylic resins such as poly (meth)acrylic acid ester or partial hydrolyzates thereof; polyvinyl alcohols or partially acetalized polyvinyl alcohols; triacetyl cellulose; polyisoprene; polybutadiene; polychloroprene; silicone rubber; polystyrene; polyvinyl butyral; polyvinyl chloride; polyacrylates; chlorinated polyethylene; chlorinated polypropylene; poly-N-vinylcarb azole or derivatives thereof; poly-N-vinylpyrrolidone or derivatives thereof polyarylate; copolymers of styrene and maleic anhydride or half esters thereof copolymers containing at least one from a copolymerizable monomer group of acrylic acid, acrylic acid ester, methacrylic acid, methacrylic acid ester, acrylamide, acrylonitrile, ethylene, propylene, vinyl chloride and vinyl acetate as a polymerization component and the like, and one or two or more of these can be used. Furthermore, a monomer containing a heat-curable or photocurable functional group as a copolymerization component can also be used.

In addition, as the matrix resin, an oligomer-type curable resin can also be used. Examples thereof include epoxy compounds generated by a fusion reaction between a variety of phenol compounds such as bisphenol A, bisphenol S, novolac, o-cresol novolac and p-alkylphenol novolac and epichlorohydrin and the like, and one or two or more of these can be used.

### [2-2-3. Photopolymerization Initiator]

A photopolymerization initiator that is contained in the composition for hologram recording of the present embodiment is not particularly limited, and an arbitrary photopolymerization initiator can be used.

As the photopolymerization initiator in the present embodiment, a radical polymerization initiator (radical generator), a cationic polymerization initiator (acid generator) or a polymerization initiator having both functions can be exemplified. As the photopolymerization initiator, an anionic polymerization initiator (base generator) may be used.

As the radical polymerization initiator (radical generator), an imidazole derivative, a bisimidazole derivative, an N-arylglycine derivative, an organic azide compound, titanocenes, an aluminate complex, an organic peroxide, an N-alkoxypyridinium salt, a thioxanthone derivative and the like can be exemplified. One or two or more may be selected from the group consisting of these.

As more specific radical polymerization initiators (radical generators), 1,3-di(t-butyldioxycarbonyl) benzophenone, 3,3′,4,4′-tetrakis(t-butyldioxycarbonyl) benzophenone, 3-phenyl-5-isooxazolone, 2-mercaptobenzimidazole, bis(2,4,5-triphenyl)imidazole, 2,2-dimethoxy-1,2-diphenylethan-1-one (trade name: Irgacure 651, manufactured by BASF), 1-hydroxy-cyclohexyl-phenyl-ketone (trade name: Irgacure 184, manufactured by BASF), 2-benzyl-2-dimethylamino-1-(4-morpholinophenyl)-butanone-1 (trade name: Irgacure 369, manufactured by BASF), bis(η5-2,4-cyclopentadiene-1-yl)-bis(2,6-difluoro-3-(1H-pyrrole-1-yl))-phenyl) titanium (trade name: Irgacure 784, manufactured by BASF) and the like can be exemplified, but the radical polymerization initiator is not limited thereto. One or two or more may be selected from the group consisting of these.

As the cationic polymerization initiator (acid generator), sulfonic acid ester, imide sulfonate, dialkyl-4-hydroxysulfonium salt, aryl sulfonic acid-p-nitrobenzyl ester, silanol-aluminum complex, (η6-benzene)(η5-cyclopentadienyl) iron (II) and the like can be exemplified. One or two or more may be selected from the group consisting of these.

As more specific cationic polymerization initiators (acid generators), benzoin tosylate, 2,5-dinitrobenzyltosylate, N-tosiphthalate imide and the like can be exemplified, but the cationic polymerization initiator is not limited thereto. One or two or more may be selected from the group consisting of these.

As a polymerization initiator that can be used as both the radical polymerization initiator (radical generator) and the cationic polymerization initiator (acid generator), diaryliodonium salt, diaryliodonium organic boron complex, aromatic sulfonium salt, aromatic diazonium salt, aromatic phosphonium salt, triazine compound, iron arene complex-based polymerization initiators and the like can be exemplified. One or two or more may be selected from the group consisting of these.

More specifically, chlorides of iodonium such as 4-isopropyl-4′-methyldiphenyliodonium tetrakis(pentafluorophenyl) borate, diphenyliodonium, ditolyliodonium, bis(p-tert-butylphenyl) iodonium and bis(p-chlorophenyl) iodonium, iodium salts such as bromide, borofluoride salt, hexafluorophosphate salt and hexafluoroantimonate salt; chlorides of sulfonium such as triphenylsulfonium, 4-tert-butyltriphenylsulfonium and tris(4-methylphenyl) sulfonium, sulfonium salts such as bromide, fluoroborate, hexafluorophosphate and hexafluoroantimonate; 2,4,6-substituted-1,3,5-triazine compounds such as 2,4,6-tris(trichloromethyl)-1,3,5-triazine, 2-phenyl-4,6-bis(trichloromethyl)-1,3,5-triazine, 2-methyl-4,6-bis(trichloromethyl)-1,3,5-triazine and other can be exemplified, but the polymerization initiator is not limited thereto. One or two or more may be selected from the group consisting of these.

### [2-2-4. Anthracene-Based Compound]

An anthracene-based compound has an effect on the control of the reaction rate of a polymerization reaction occurring in a bright portion during interference exposure and is thus preferable. Since the control of the reaction rate advantageously acts on the formation of the separation structures of holograms, the anthracene-based compound is capable of improving the diffraction characteristics of a hologram to be obtained and is thus preferable. In addition, the anthracene-based compound has a specific absorption range derived from an anthracene skeleton on the long wavelength side (near 350 nm to 400 nm) and thus has a high UV absorption efficiency, is capable of increasing the energy use efficiency of UV in UV irradiation steps and is capable of suppressing substances that yellow due to UV being irradiated with UV. Therefore, the use of the anthracene-based compound suppresses the yellowing of holograms and makes it possible for the transparency to become favorable.

The anthracene-based compound is preferably a compound represented by the following general formula (5).

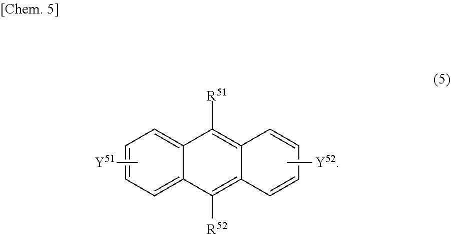

In the general formula (5), examples of R⁵¹ and R⁵² include alkyl groups (C₁₋₁₂ alkyl groups such as a methyl group, an ethyl group, a propyl group, an isopropyl group and a butyl group and the like); cycloalkyl groups (a cyclohexyl group and the like); aryl groups (a phenyl group, a tolyl group, a xylyl group, a naphthyl group and the like); hydrocarbon groups such as aralkyl groups (a benzyl group, a phenethyl group and the like); group-OR⁵³ [in the formula, R⁵³ represents a hydrogen atom or a hydrocarbon group (the above-exemplified hydrocarbon group or the like)] such as alkoxy groups (C₁₋₁₂ alkoxy groups such as a methoxy group and an ethoxy group and the like), hydroxyalkyl groups (a hydroxymethyl group, a hydroxyethyl group and the like), cycloalkoxy groups (cyclohexyloxy groups and the like), aryloxy groups (a phenoxy group and the like), aralkyloxy groups (a benzyloxy group and the like) and the like; group-SR³⁵ (in the formula, R⁵³ is the same as above) such as alkylthio groups (a methylthio group, an ethylthio group and the like), cycloalkylthio groups (a cyclohexylthio group and the like), arylthio groups (a thiophenoxy group and the like), aralkylthio groups (a benzylthio group and the like) and the like; acyl groups (an acetyl group and the like); alkoxycarbonyl groups (a methoxycarbonyl group and the like); a hydrogen atom; halogen atoms (a fluorine atom, a chlorine atom, a bromine atom, an iodine atom and the like); nitro groups; cyano groups; substituted amino groups (dialkylamino groups such as a dimethylamino group) and the like. One or two or more may be selected from the group consisting of these.

In the general formula (5), R⁵¹ and R⁵² may be identical to or different from each other.

In the general formula (5), examples of Y⁵¹ and Y⁵² include alkyl groups (C₁₋₁₂ alkyl groups such as a methyl group, an ethyl group, a propyl group, an isopropyl group, a butyl group and a t-butyl group and the like), hydrocarbon groups such as aryl groups (C₆₋₁₀ aryl groups such as a phenyl group and the like); a hydrogen atom; halogen atoms (a fluorine atom, a chlorine atom, a bromine atom and the like) and the like. One or two or more may be selected from the group consisting of these.

In the general formula (5), Y⁵¹ and Y⁵² may be identical to or different from each other.

The anthracene compound represented by the general formula (5) can be synthesized by a variety of well-known synthesis methods and can be synthesized based on, for example, the synthesis method described in JP 2018-018061 A.

In the present embodiment, among the anthracene-based compounds represented by the general formula (5), for example, 9,10-dibutoxyanthracene (manufactured by Kawasaki Kasei Chemicals Ltd., “UVS-1331”), 9,10-diethoxyanthracene (manufactured by Kawasaki Kasei Chemicals Ltd., “UVS-1101”), 2-tert-butyl anthracene (manufactured by Tokyo Chemical Industry Co., Ltd.), 9-(hydroxyethyl)anthracene (manufactured by Tokyo Chemical Industry Co., Ltd.) and N-phenyl-9-anthramine (manufactured by Tokyo Chemical Industry Co., Ltd.) are preferably used.

The content of the anthracene-based compound in the composition for hologram recording may be appropriately set by a person in the art, but is preferably 0.08 to 10 mass % and more preferably 0.08 to 7 mass % with respect to the total mass of the composition for hologram recording from the viewpoint of improving UV absorption by the anthracene-based compound. When the content of the anthracene-based compound is 0.08 mass % or more, it is easy for UV absorption by the anthracene-based compound to be sufficiently exhibited. On the other hand, when the content of the anthracene-based compound is 10 mass % or less, it is easy to avoid a concern of crystallization depending on the type of the anthracene-based compound.

### [2-2-5. Plasticizer]

The composition for hologram recording of the present embodiment may contain a plasticizer. The plasticizer is effective for preparing the adhesion, flexibility, hardness and other physical characteristics of the composition for hologram recording.

As the plasticizer, for example, triethylene glycol, triethylene glycol diacetate, triethylene glycol dipropionate, triethylene glycol dicaprylate, triethylene glycol dimethyl ether, poly(ethylene glycol), poly(ethylene glycol) methyl ether, triethylene glycol bis(2-ethyl hexanoate), tetraethylene glycol diheptanoate, diethyl sebacate, dibutyl sebacate, tris(2-ethylhexyl) phosphate, isozorobil naphthalene, diisopropyl naphthalene, poly(propylene glycol), glyceryl tributyrate, diethyl adipate, diethyl sebacate, suberic acid monobuyl, tributyl phosphate, tris(2-ethylhexyl) phosphate and the like can be exemplified, and one or two or more of these can be used.

In addition, as the plasticizer, a cationic polymerizable compound can be used. Examples of the cationic polymerizable compound include epoxy compounds, oxetane compounds and the like. The plasticizer of the present embodiment is preferably a cationic polymerizable compound since the cationic polymerizable compound is cured after exposure and is capable of improving the retainability of the diffraction characteristics of holograms to be obtained, and, in particular, one or two or more selected from epoxy compounds and oxetane compounds are more preferably used.

As the epoxy compound, for example, glycidyl ethers and the like can be used. As the glycidyl ethers, more specifically, allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, 1,12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, pentaerythritol polyglycidyl ether and the like can be exemplified, and one or two or more of these can be used.

As the oxetane compound, for example, 3-ethyl-3-hydroxymethyl oxetane, 2-ethylhexyl oxetane, xylylenebis oxetane, 3-ethyl-3{[(3-ethyloxetane-3-yl)methoxy]methyl} oxetane, 2-hydroxyethyl vinyl ether, 4-hydroxybutyl vinyl ether, diethylene glycol monovinyl ether, 2-ethylhexyl vinyl ether and the like can be exemplified, and one or two or more of these can be used.

The content of the plasticizer in the composition for hologram recording may be appropriately set by a person in the art, but is preferably 5 to 40 mass % with respect to the total mass of the composition for hologram recording.

### [2-2-6. Polymerization Initiator]

The composition for hologram recording of the present embodiment may contain a polymerization inhibitor. The polymerization inhibitor is not particularly limited, examples thereof include quinone-based compounds such as hydroquinone; hindered phenol-based compounds; benzotriazole compounds; thiazine-based compounds such as phenothiazine; and the like, and one or two or more of these can be used.

The content of the polymerization inhibitor in the composition for hologram recording may be appropriately set by a person in the art, but is preferably 0.01 to 1.0 mass % and more preferably 0.05 to 0.5 mass % with respect to the total mass of the composition for hologram recording.

### [2-2-7. Other Components]

The composition for hologram recording of the present embodiment may contain, in addition to the above-described components, inorganic fine particles, a sensitizing dye, a chain transfer agent, a solvent or the like as necessary.

The composition for hologram recording of the present embodiment may contain inorganic fine particles. The use of inorganic fine particles makes it possible to enhance the diffraction characteristics (preferably the amount of refractive index modulation (Δn) or the clarity of the diffraction grating structure), which is preferable. The inorganic fine particles are not particularly limited, but are preferably TiO₂ fine particles or ZrO₂ fine particles.

In the composition for hologram recording of the present embodiment, one kind of inorganic fine particles may be contained or two or more kinds of inorganic fine particles may be contained. For example, the above-described TiO₂ fine particles and ZrO₂ fine particles may be jointly used.

The composition for hologram recording of the present embodiment contains, as a preferable aspect, at least the above-described monofunctional and polyfunctional acrylate or methacrylate and TiO₂ fine particles.

In addition, the composition for hologram recording of the present embodiment contains, as a preferable aspect, at least the above-described monofunctional and polyfunctional acrylate or methacrylate and ZrO₂ fine particles.

The content of the inorganic fine particles in the composition for hologram recording may be appropriately set by a person in the art, but is preferably 15 to 85 mass % with respect to the total mass of the composition for hologram recording.

The sensitizing dye is capable of intensifying the sensitivity of the photopolymerization initiator to light. More specifically, a thiopyrylium salt-based dye, a merocyanine-based dye, a quinoline-based dye, a rose bengal-based dye, a styrylquinoline-based dye, a ketocoumarin-based dye, a thioxanthene-based dye, a xanthene-based dye, an oxonol-based dye, a cyanine-based dye, a rhodamine-based dye, a pyrylium salt-based dye, a cyclopentanone-based dye, a cyclohexanone-based dye and the like can be exemplified. One or two or more may be selected from the group consisting of these.

Specific examples of the cyanine-based dye and the merocyanine-based dye include 3,3′-dicarboxyethyl-2,2′-thiocyanine bromide, 1-carboxymethyl-1′-carboxyethyl-2,2′-quinocyanine bromide, 1,3′-diethyl-2,2′-quinothiacyanine iodide, 3-ethyl-5-[(3-ethyl-2(3H)-benzothiazolylidene)ethylidene]-2-thioxo-4-oxazolidine and the like.

Specific examples of the coumarin-based dye and the ketocoumarin-based dye include 3-(2′-benzimidazole)-7-diethylaminocoumarin, 3,3′-carbonylbis(7-diethylaminocoumarin), 3,3′-carbonylbiscoumarin, 3,3′-carbonylbis(5,7-dimethoxycoumarin), 3,3′-carbonylbis(7-acetoxycoumarin) and the like. One or two or more of these specific examples can be used.

The chain transfer agent pulls out a radical from the growing end of a polymerization reaction to stop growth, becomes a new polymerization reaction initiation species, and is added to a radical polymerizable monomer so as to be capable of initiating the growth of a new polymer. When the chain transfer agent is used, the frequency of the chain transfer of radical polymerization is increased, which makes it possible to increase the reaction rate of the radical polymerizable monomer and to improve the sensitivity to light. In addition, when the reaction rate of the radical polymerizable monomer increases, and a reaction-contributing component increases, it is possible to adjust the degree of polymerization of the radical polymerizable monomer.

Examples of the chain transfer agent include α-methylstyrene dimer, 2-mercaptobenzoxazole, 2-mercaptobenzothiazole, tert-butyl alcohol, n-butanol, isobutanol, isopropylbenzene, ethylbenzene, chloroform, methyl ethyl ketone, propylene, vinyl chloride and the like, and one or two or more of them can be used.

The solvent can be effective not only for viscosity adjustment and compatibility adjustment but also for improvement in the film-forming property.

Examples of the solvent include acetone, xylene, toluene, methyl ethyl ketone, tetrahydrofuran, benzene, methylene chloride, dichloromethane, chloroform, methanol and the like, and one or two or more of them can be used.

### <2-3. Method for Producing Composition for Hologram Recording>

The composition for hologram recording of the first embodiment according to the present technique can be blended and produced so as to become a configuration in which a cross-sectional observation image at the time of observing a hologram recording film by the atomic force microscopy (AFM) has a diffraction grating structure indicating that there is a material density difference that can be observed by the AFM. Such a composition can be produced by appropriately using the individual components and the like described in <2. First embodiment (composition for hologram recording)>. The composition for hologram recording of the present embodiment is preferably produced so as to contain at least a radical polymerizable monomer and a matrix resin.

As an example of a method for producing the composition for hologram recording of the present embodiment, the composition for hologram recording can be produced by adding a radical polymerizable monomer, a matrix resin, a photopolymerization initiator, an anthracene-based compound and the like in predetermined amounts to the above-described solvent at normal temperature (for example, 10° C. to 30° C.) and dissolving and mixing the components, but the production method is not limited thereto.

In addition, the above-described inorganic fine particles, plasticizer, polymerization initiator, sensitizing dye, chain transfer agent and the like may be added to the composition for hologram recording of the present embodiment depending on the application, objective or the like.

When the composition for hologram recording of the first embodiment according to the present technique is used for a hologram recording medium to be described below, the composition for hologram recording may be used as an application liquid.

### 3. Second Embodiment (Hologram Recording Medium)

### [3-1. Hologram Recording Medium]

A hologram recording medium of a second embodiment according to the present technique has a photocurable resin layer that becomes a configuration in which a cross-sectional observation image at the time of observing a hologram recording film by the atomic force microscopy (AFM) has a diffraction grating structure indicating that there is a material density difference that can be observed by the AFM. At this time, the hologram recording medium preferably contains at least a radical polymerizable monomer and a matrix resin. The hologram recording medium more preferably includes a photocurable resin layer containing at least a radical polymerizable monomer, a matrix resin, a photopolymerization initiator and an anthracene-based compound.

The hologram recording medium of the present embodiment contains the composition for hologram recording of the first embodiment according to the present technique.

The hologram recording medium of the present embodiment may include a photocurable resin layer and at least one transparent base material, and the photocurable resin layer may be formed on the at least one transparent base material.

Here, a schematic cross-sectional view of an example of the hologram recording medium of the present embodiment is shown in FIG. 1. A hologram recording medium 1 shown in the drawing is as described in the <1. Summary of present technique>.

According to the hologram recording medium of the second embodiment according to the present technique, it is possible to obtain a hologram having excellent diffraction characteristics (for example, a large amount of refractive index modulation (Δn) and a high clarity of the diffraction grating structure) without undergoing a heating step after exposure. In addition, according to the hologram recording medium, it is possible to improve the transparency of holograms.

### [3-2. Photocurable Resin Layer]

The photocurable resin layer contained in the hologram recording medium of the second embodiment according to the present technique preferably contains a component that becomes a configuration in which a cross-sectional observation image at the time of observing a hologram recording film by the atomic force microscopy (AFM) has a diffraction grating structure indicating that there is a material density difference that can be observed by the AFM. The photocurable resin layer preferably contains at least a radical polymerizable monomer and a matrix resin and more preferably further contains a polymerization inhibitor and/or an anthracene-based compound. The photocurable resin layer still more preferably contains at least a radical polymerizable monomer, a matrix resin, a photopolymerization initiator and an anthracene-based compound.

The photocurable resin layer contains a material of the composition for hologram recording of the first embodiment according to the present technique, and all of the contents described regarding each material in the <2.> are also true for the photocurable resin layer of the hologram recording medium in the present embodiment. The photocurable resin layer of the hologram recording medium may be composed of the composition for hologram recording of the first embodiment according to the present technique and other materials or may be composed of the composition for hologram recording of the first embodiment according to the present technique.

The thickness of the photocurable resin layer of the hologram recording medium of the present embodiment may be appropriately set by a person in the art, but is preferably 0.1 to 100 μm and more preferably 1 to 30 μm from the viewpoint of the diffraction efficiency and the sensitivity to light.

### [3-3. Transparent Base Material]

The hologram recording medium of the second embodiment of the present technique may include at least one transparent base material. As the transparent base material, a glass substrate, a substrate of a resin having transparency or the like may be used.

Specific examples of the substrate of a resin having transparency include a polyester film, for example, a polyethylene film, a polypropylene film, a polyethylene fluoride-based film, a polyvinylidene fluoride film, a polyvinyl chloride film, a polyvinylidene chloride film, an ethylene-vinyl alcohol film, a polyvinyl alcohol film, a polymethyl methacrylate film, a polyether sulfone film, a polyether ether ketone film, a polyamide film, a tetrafluoroethylene-perfluoroalkyl vinyl copolymer film, a polyethylene terephthalate film or the like; a polyimide film and the like. One or two or more may be selected from the group consisting of these.

The thickness of the transparent base material of the hologram recording medium of the present embodiment may be appropriately set by a person in the art, but is preferably 0.1 to 100 μm and more preferably 1 to 30 μm from the viewpoint of the transparency and stiffness of the hologram recording medium. As a protective film of the hologram recording medium, the film exemplified above can be used, and it is possible to laminate the film on the application surface. In this case, a release treatment may be carried out on the contact surface between the laminated film and the application surface such that the protective layer is easily peeled off from the back.

### [3-4. Method for Manufacturing Hologram Recording Medium]

The hologram recording medium of the second embodiment according to the present technique can be obtained by, for example, applying an application liquid made of the composition for hologram recording described in the <2.> onto the transparent base material using a spin coater, a gravure coater, a comma coater, a bar coater or the like and then drying the application liquid to form a photocurable resin layer.

### 4. Third Embodiment (Hologram)

### [4-1. Hologram]

A hologram of a third embodiment according to the present technique is obtained using the hologram recording medium of the second embodiment according to the present technique (for example, refer to FIG. 2A). The hologram of the present embodiment can be obtained by, for example, carrying out exposure and UV irradiation on the hologram recording medium by a method to be described below. The hologram contains, for example, at least a polymer and/or oligomer including a configuration unit derived from a radical polymerizable monomer and a matrix resin, a photopolymerization initiator having a structure changed due to an active species generated by irradiation with external energy and a decolorized body of a sensitizing dye. The hologram includes a hologram film and a holographic optical element.

The hologram of the third embodiment according to the present technique has excellent diffraction characteristics (for example, a large amount of refractive index modulation (Δn) and a high clarity of the diffraction grating structure) without undergoing a heating step after exposure. In addition, the hologram also has favorable transparency.

In the case of containing an anthracene-based compound, the hologram of the present embodiment has a specific absorption range derived from an anthracene skeleton on the long wavelength side (near 350 nm to 400 nm).

### [4-2. Method for Manufacturing Hologram]

The hologram of the third embodiment according to the present technique can be obtained by, for example, carrying out dual beam exposure on the hologram recording medium of the second embodiment according to the present technique using a semiconductor laser in a visible light region, then, curing an uncured monomer or the like by irradiating the entire surface with UV (ultraviolet rays) and fixing the refractive index distribution to the hologram recording medium. The dual beam exposure conditions may be appropriately set by a person in the art depending on the application, objective or the like of the hologram; however, preferably, it is desirable to set the light intensity of single beam on the hologram recording medium to 0.1 to 100 mW/cm², carry out exposure for 1 to 1000 seconds and carry out interference exposure with the angle formed by dual beam set to be 0.1 to 179.9 degrees.

### 5. Fourth Embodiment (Optical Device and Optical Member)

In an optical device and an optical member of a fourth embodiment according to the present technique, the hologram of the third embodiment according to the present technique is used.

As the optical device and the optical member, for example, image display devices such as eyewear, holographic screens, transparent displays, head-mounted displays and head-up displays, image capturing devices, image capturing elements, color filters, diffractive lenses, light guide plates, spectroscopic elements, hologram sheets, information recording media such as optical disks and magneto optical disks, optical pickup devices, polarizing microscopes, sensors and the like can be exemplified. One or two or more may be selected from the group consisting of these.

In the optical device and the optical member of the fourth embodiment according to the present technique, a hologram having excellent diffraction characteristics is used. Therefore, it is possible to realize an optical device and an optical member having high optical characteristics and high optical stability. Furthermore, since the optical device and the optical member according to the present embodiment also have favorable transparency, for example, in a case where the present technique is used for displays, it is possible to provide a high see-through property to the displays.

Embodiments according to the present technique are not limited to the above-described embodiments, and a variety of modifications are possible within the scope of the gist of the present technique.

The present technique can also be configured as described below.

[1]

A composition for hologram recording containing at least a radical polymerizable monomer and a matrix resin,

in which a cross-sectional observation image at the time of observing a hologram recording film by atomic force microscopy (AFM) has a diffraction grating structure indicating that there is a material density difference that can be observed by the AFM.

[2]

A composition for hologram recording containing at least a radical polymerizable monomer and a matrix resin (preferably polyvinyl acetate).

[3]

The composition for hologram recording according to [1] or [2], in which, when the cross-sectional observation image has been Fourier-transformed, a periodic structure-derived peak is observed at a wavenumber position with a different origin of a power spectrum.

[4]

The composition for hologram recording according to [3], in which the periodic structure-derived peak is three or more times higher than a noise waveform of a baseline.

[5]

The composition for hologram recording according to any one of [1] to [4], in which an amount of refractive index modulation Δn is 0.04 or more and preferably 0.05 or more.

[6]

The composition for hologram recording according to any one of [1] to [5], in which a clarity of the diffraction grating structure is 2.0 nm or more and preferably 4.0 nm or more.

Regarding the clarity of the diffraction grating structure, it is preferable that, in the diffraction grating structure portion in the shape image of the cross-sectional observation image, a region is divided such that there is at least one section where at least crests and troughs of the periodic structure are included, and the mode of the standard deviation values of the divided regions (local region standard deviations) is defined as the clarity of the diffraction grating structure. The height difference of the crests and troughs of the periodic structure is preferably a height difference of 2 nm or more and/or 100 nm or less (more preferably 20 nm or less).

[7]

The composition for hologram recording according to any one of [1] to [6] that is further a polymerization initiator and/or an anthracene-based compound (preferably 9,10-dibutoxyanthracene).

[8]

The composition for hologram recording according to any one of [1] to [7], in which the radical polymerizable monomer is a plurality of radical polymerizable monomers having different refractive indexes.

[9]

A hologram recording medium having a photocurable resin layer for which the composition for hologram recording according to any one of [1] to [8] is used.

[10]

A hologram recording medium containing at least a radical polymerizable monomer and a matrix resin, and

having a photocurable resin layer in which a cross-sectional observation image at the time of observing a hologram recording film by atomic force microscopy (AFM) has a diffraction grating structure indicating that there is a material density difference that can be observed by the AFM.

[11]

The hologram recording medium according to [9] or [10], in which, when the cross-sectional observation image has been Fourier-transformed, a periodic structure-derived peak is observed at a wavenumber position with a different origin of a power spectrum.

[12]

The hologram recording medium according to any one of [9] to [11], in which the periodic structure-derived peak is three or more times higher than a noise waveform of a baseline.

[13]

The hologram recording medium according to any one of [9] to [12], in which an amount of refractive index modulation Δn is 0.04 or more.

[14]

The hologram recording medium according to any one of [9] to [13], in which a clarity of the diffraction grating structure is 2 nm or more.

[15]

The hologram recording medium according to any one of [9] to [14] that is further a polymerization initiator and/or an anthracene-based compound.

[16]

The hologram recording medium according to any one of [9] to [15] configured such that the radical polymerizable monomer is a plurality of radical polymerizable monomers having different refractive indexes.

[17]

A hologram obtained using the hologram recording medium according to any one of [10] to [16].

[18]

A hologram or a hologram recording film, in which a cross-sectional observation image at the time of observing a hologram recording film by atomic force microscopy (AFM) has a diffraction grating structure indicating that there is a material density difference that can be observed by the AFM.

[19]

An optical device or optical member having the hologram according to [17] or [18]

### EXAMPLES

Hereinafter, the effects of the present technique will be specifically described using Experiment Examples, examples or the like. The scope of the present technique is not limited to the present [examples].

### Experiment Examples 1 to 8

### <Preparation of Compositions for Hologram Recording 1 to 4>

As radical polymerizable monomers, bisphenoxyethanolfluorene diacrylate and 2-(9H-carbazol-9-yl)ethyl acrylate, as a matrix resin, polyvinyl acetate, as a plasticizer, 1,6-hexanediol diglycidyl ether, as a sensitizing dye, rose bengal, as a polymerization initiator, 4-isopropyl-4′-methyldiphenyliodonium tetrakis(pentafluorophenyl) borate, as a chain transfer agent, 2-mercaptobenzoxazole, and, as an anthracene-based compound, 9,10-dibutoxyanthracene were mixed according to amounts shown in Table 1 below in an acetone solvent at normal temperature (approximately 10° C. to 30° C.) under shading, thereby preparing compositions of compositions for hologram recording 1 to 4.
Radical polymerizable monomer; bisphenoxyethanolfluorene diacrylate (manufactured by Osaka Gas Chemicals Co., Ltd., “EA-0200”, refractive index: 1.62) 2-(9H-carbazol-9-yl)ethyl acrylate (manufactured by Sigma-Aldrich Co. LLC, “EACz”, refractive index: 1.65)
Matrix resin; polyvinyl acetate (manufactured by Denka Company Limited, “SN-55T”)
Plasticizer; 1,6-hexanediol diglycidyl ether (manufactured by Nagase ChemteX Corporation, “EX-212L”)
Sensitizing dye; rose bengal (manufactured by Sigma-Aldrich Co. LLC, “RB”)
Polymerization initiator; 4-isopropyl-4′-methyldiphenyliodonium tetrakis(pentafluorophenyl) borate (manufactured by Tokyo Chemical Industry Co., Ltd., “I0591”)
Chain transfer agent; 2-mercaptobenzoxazole (manufactured by Tokyo Chemical Industry Co., Ltd., “2-MBO”)
Polymerization inhibitor; phenothiazine (manufactured by FUJIFILM Wako Pure Chemical Corporation, “PT”)
Anthracene-based compound; 9,10-dibutoxyanthracene (manufactured by Kawasaki Kasei Chemicals Ltd., “UVS1331”)

### <Production of Hologram Recording Media 1 to 4>

A polyvinyl alcohol was applied in a film thickness of 5 μm onto an optical film for a base material of a cycloolefin polymer (manufactured by Zeon Corporation, “ZEONORFILM”). Furthermore, a film of the composition for hologram recording 1 was formed with a bar coater on a 5 μm-thick polyvinyl alcohol film such that the film thickness reached 10 to 11 μm, and a laminate of “base material/PVA/photocurable resin layer (unexposed film for hologram recording)” was produced.

Next, this laminate was laminated on a 1 mm-thick glass substrate to which PVA had been applied with a hand roller, then, the optical film for a base material was peeled off, and a hologram recording medium 1 including “PVA/photocurable resin layer/PVA/glass substrate” laminated in this order was obtained.

Hologram recording media was produced in the same manner as described above except that the composition for hologram recording 1 used for the photocurable resin layer was changed to the compositions for hologram recording 2 to 4, and hologram recording media 2 to 4 were obtained.

TABLE 1

| Composition | | Trade | Composition | Composition | Composition | Composition |
|---|---|---|---|---|---|---|
| (mass %) | Compound name | name | 1 | 2 | 3 | 4 |
| Monomer 1 | Bisphenoxyethanolfluorene | EA-0200 | 36.8 | 36.8 | 36.8 | 36.8 |
| | diacrylate (refractive index: | | | | | |
| | 1.62) | | | | | |
| Monomer 2 | 2-(9H-carbazol-9-yl)ethyl | EACz | 8.2 | 8.2 | 8.2 | 8.2 |
| | acrylate (refractive index: | | | | | |
| | 1.65) | | | | | |
| Matrix | Polyvinyl acetate | SN-55T | 19.38 | 19.38 | 19.38 | 19.38 |
| Plasticizer | 1,6-Hexanediol diglycidyl | EX212L | 30 | 30 | 30 | 30 |
| | ether | | | | | |
| Sensitizing dye | Rose bengal | RB | 2.25 | 2.25 | 2.25 | 2.25 |
| Initiator | 4-Isopropyl-4′- | I0591 | 8.43 | 8.43 | 8.43 | 8.43 |
| | methyldiphenyliodonium | | | | | |
| | tetrakis(pentafluorophenyl) | | | | | |
| | borate | | | | | |
| Chain transfer | 2-Mercaptobenzoxazole | 2-MB0 | 0.56 | 0.56 | 0.56 | 0.56 |
| agent | | | | | | |
| Polymerization | Phenothiazine | PT | 0.152 | — | 0.152 | — |
| inhibitor | | | | | | |
| Anthracene-based | 9,10-Dibutoxyanthracene | UVS1331 | 2.67 | 2.67 | — | — |
| compound | | | | | | |

TABLE 2

| | | Condition1 | Condition2 |
|---|---|---|---|
| Exposure | Wavelength/nm | 532 | 532 |
| conditions | Exposure amount/ | 510 | 450 |
| | mJ · cm\hat{ }2 | | |

### <Production of Holograms 1, 3, 5 and 7 (Exposure Condition 1)>

Dual beam exposure was carried out on each of the hologram recording media 1 to 4 using a semiconductor laser having an exposure wavelength of 532 nm under an exposure condition 1 (exposure amount: 510 mJ/cm²), then, an uncured monomer was cured by irradiating the entire surface with UV (ultraviolet rays), and the refractive index distribution was fixed to the medium 1. Regarding the dual beam exposure conditions, the light intensity of single beam on the recording medium was set to 2.6 mW/cm², exposure was carried out for 30 seconds, and interference exposure was carried out such that the angle formed by dual beam reached 3.0 degrees. Therefore, refractive index distributions were formed in the hologram recording media 1 to 4, respectively, and holograms 1, 3, 5 and 7 were obtained.

### <Production of Holograms 2, 4, 6 and 8 (Exposure Condition 2)>

Refractive index distributions were formed in the hologram recording media 1 to 4, respectively, in the same manner as in the above-described production of holograms except that the exposure condition 1 (exposure amount: 510 mJ/cm²) was changed to an exposure condition 2 (exposure amount: 450 mJ/cm²), and holograms 2, 4, 6 and 8 were obtained.

Regarding the hologram recording media 1 to 3, it is possible to form a hologram having favorable diffraction characteristics even under an exposure condition exposure amount of 156 mJ/cm².

### (Evaluation of Hologram 1)

The amount of refractive index modulation (Δn) and the transparency (yellowing after UV irradiation) of the produced hologram 1 were evaluated by the following methods.

<Method for Measuring Amount of Refractive Index Modulation (Δn)>

The amount of refractive index modulation (Δn) can be evaluated from the maximum transmittance and half-value width of a transmission spectrum obtained by injecting light to the hologram using Kogelnik's coupled-wave theory (Bell System Technical Journal, 48, 2909 (1969)).

The transmission spectrum can be obtained by measuring transmittance at 400 to 700 nm using a spot light source manufactured by Hamamatsu Photonics K.K. as a light source and a small-sized fiber optic spectrometer USB-4000 manufactured by Ocean Optics, Inc. as a spectrometer.

### <Method for Measuring Transmittance>

The transmission spectrum can be obtained by measuring transmittance at 400 to 700 nm using a spot light source manufactured by Hamamatsu Photonics K.K. as a light source and a small-sized fiber optic spectrometer USB-4000 manufactured by Ocean Optics, Inc. as a spectrometer.

### <Method for Measuring Transparency>

The transparency was regarded as “small” in a case where the obtained hologram 1 was visually evaluated and slightly yellowed and regarded as “large” in the case of being significantly yellowed.

### <Method for Evaluating Diffraction Characteristics of Hologram by Atomic Force Electron Microscopy (AFM)>

The diffraction characteristics of the hologram were evaluated by the atomic force electron microscopy (AFM) in the order of S01 to S08 described in the above-described <method for evaluating diffraction characteristics of hologram by atomic force electron microscopy (AFM)> (refer to FIG. 2).

Observation by the atomic force electron microscopy (AFM) was carried out under the following conditions.

Atomic force electron microscope: E-sweep and Nano Navi manufactured by Seiko Instruments Inc.,

Cantilever: Olympus OMCL-AC240TS

Measurement frequency: High frequency side or low frequency side of resonant frequency

Vibration amplitude: 0.1 V

Scanning frequency: 1.0 Hz

Measurement area: 5 to 10 μm□

Number of sampling points: 512×512 pixels

### <Possibility of Diffraction Grating Observation>

In a case where a diffraction grating pattern attributed to crests and troughs of a high difference of 2 nm or more is observed in a film-corresponding portion in a shape image acquired by the AFM, the diffraction grating is regarded as observable (possible), and, in a case where the height difference is less than 2 nm, the diffraction grating is regarded as unobservable (impossible). The diffraction grating pattern in the present technique is most typically a structure in which a number of parallel linear crests and troughs are arranged at equal intervals due to the interference fringes of light, but also includes patterns in which a shape formed of crests and troughs is curved or the intervals exponentially change.

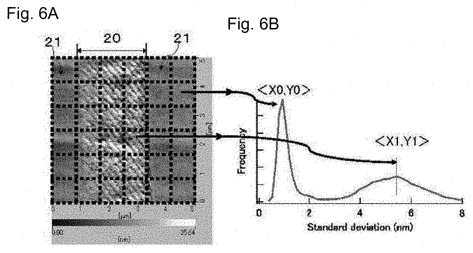

In Experiment Example 1, 512×512 pixels were divided into division sizes of 21×21 pixels. Standard deviations in certain sections were obtained. In the divided region, a map and a histogram were produced based on the standard deviations of individual sections. In this histogram, two or more peaks (X0) were observed. At this time, protective film-derived peaks (X0, Y0) and a hologram recording film-derived peak were recognized, and the mode of the peak farthest from X0 was regarded as the clarity. The above-described operation n was carried out three times, and the results of the average value are shown in Table 3 (refer to FIG. 6). The same operation was carried out on Experiment Examples 2 to 9 in the same order, and the clarities are shown in Table 3. In Experiment Examples 7 and 8, since the numbers of peaks were less than 2, and the differences in crests and troughs between the protective film and the hologram recording film were considered to be not large, the clarity was regarded as incalculable (−). In the AFM observation of Experiment Examples 7 and 8 as well, similarly, no large differences in crests and troughs were shown, and the diffraction grating was unobservable. In addition, the height differences of crests and troughs in Experiment Examples 1 to 6 were in a range of 2 nm or more and 50 nm or less.

TABLE 3

| | | | Possibility of | | Amount of |
|---|---|---|---|---|---|
| | Composition | | diffraction | Impossible | refractive |
| | for hologram | Exposure | grating | Clarity | index modulation |
| | recording | condition | observation | (nm) | (Δn) |
| Experiment | Composition1 | Exposure | Possible | 5.10 | 0.06 |
| Example 1 | | condition1 | | | |
| Experiment | Composition1 | Exposure | Possible | 4.34 | 0.06 |
| Example2 | | condition2 | | | |
| Experiment | Composition2 | Exposure | Possible | 3.54 | 0.05 |
| Example3 | | condition1 | | | |
| Experiment | Composition2 | Exposure | Possible | 3.42 | 0.05 |
| Example4 | | condition2 | | | |
| Experiment | Composition3 | Exposure | Possible | 2.90 | 0.04 |
| Example5 | | condition1 | | | |
| Experiment | Composition3 | Exposure | Possible | 2.75 | 0.04 |
| Example6 | | condition2 | | | |
| Experiment | Composition4 | Exposure | Not possible | — | 0.03 |
| Example7 | | condition1 | | | |
| Experiment | Composition4 | Exposure | Not possible | — | 0.03 |
| Example8 | | condition2 | | | |

As shown in Table 3, when the hologram was formed from the composition for hologram recording containing at least the radical polymerizable monomer and the matrix resin and the cross-sectional observation image at the time of observing the hologram recording film layer in the hologram by the AFM had a diffraction grating structure indicating that there was a material density difference that could be observed by the AFM, the diffraction characteristics (the clarity and the amount of refractive index modulation Δn) were favorable. In a case where the cross-sectional observation image of the hologram recording film having favorable diffraction characteristics was Fourier-transformed, it was possible to observe a periodic structure-derived peak (peak P) at a wavenumber position with a different origin (peak O) of the power spectrum. Furthermore, in a case where this periodic structure-derived peak was three or more times higher than the noise waveform of the baseline, the diffraction characteristics were more favorable.

As shown in Table 3, in the present compositions 1 to 3, it was possible to obtain hologram recording films having excellent diffraction characteristics of a clarity of a hologram diffraction grating of 2.7 nm or more and/or an amount of refractive index modulation Δn of 0.04 or more.

In the compositions 1 to 3 used at this time, at least the polymerization inhibitor and/or the anthracene-based compound were contained, and, when the hologram recording film was formed from the composition 1 in which both the polymerization inhibitor and the anthracene-based compound were used, it was possible to obtain a hologram recording film having extremely excellent diffraction characteristics of a clarity of 5 nm or more and an amount of refractive index modulation Δn of 0.06 or more.

Between the clarities and the amounts of refractive index modulation Δn in Experiment Examples 1 to 6, it was possible to obtain a high correlation coefficient of R2=0.895. From this fact, it can be said that the use of the clarity of the present technique makes it possible to more accurately evaluate the diffraction characteristics of hologram recording films.

In addition, in the compositions 1 to 3 at this time, the anthracene-based compound was contained, and the plurality of radical polymerizable monomers having different refractive indexes was contained. As described above, the use of the anthracene-based compound or the plurality of radical polymerizable monomers having different refractive indexes made it possible to obtain a hologram recording film having extremely excellent diffraction characteristics.

Therefore, it is possible to provide a composition for hologram recording containing at least a radical polymerizable monomer and a matrix resin, in which a cross-sectional observation image at the time of observing a hologram recording film by atomic force microscopy (AFM) has a diffraction grating structure indicating that there is a material density difference that can be observed by the AFM. This composition makes it possible to obtain a hologram recording film having excellent diffraction characteristics.

### REFERENCE SIGNS LIST

1 Hologram recording medium
11 Transparent protective film
12 Photocurable resin layer
13 Film substrate (transparent base material)
20 Hologram
21 Transparent protective film
22 Hologram recording film
31 Embedding resin
32 Holder for cross section cutting
33 Knife

1. A composition for hologram recording comprising at least:
a radical polymerizable monomer; and
a matrix resin,
wherein a cross-sectional observation image at the time of observing a hologram recording film by atomic force microscopy (AFM) has a diffraction grating structure indicating that there is a material density difference that can be observed by the AFM.

2. The composition for hologram recording according to claim 1,
wherein, when the cross-sectional observation image has been Fourier-transformed, a periodic structure-derived peak is observed at a wavenumber position with a different origin of a power spectrum.

3. The composition for hologram recording according to claim 2,
wherein the periodic structure-derived peak is three or more times higher than a noise waveform of a baseline.

4. The composition for hologram recording according to claim 1,
wherein an amount of refractive index modulation Δn is 0.04 or more.

5. The composition for hologram recording according to claim 1,
wherein a clarity of the diffraction grating structure is 2 nm or more.

6. The composition for hologram recording according to claim 1, further comprising:
a polymerization inhibitor; and/or
an anthracene-based compound.

7. The composition for hologram recording according to claim 1,
wherein the radical polymerizable monomer is a plurality of radical polymerizable monomers having different refractive indexes.

8. A hologram recording medium comprising at least:
a radical polymerizable monomer; and
a matrix resin,
the hologram recording medium comprising:
a photocurable resin layer in which a cross-sectional observation image at the time of observing a hologram recording film by atomic force microscopy (AFM) has a diffraction grating structure indicating that there is a material density difference that can be observed by the AFM.

9. A hologram recording film,
wherein a cross-sectional observation image at the time of observing a hologram recording film by atomic force microscopy (AFM) has a diffraction grating structure indicating that there is a material density difference that can be observed by the AFM.

10. A hologram obtained using the hologram recording medium according to claim 8.

11. An optical device comprising:
the hologram according to claim 10.

12. An optical member comprising:
the hologram according to claim 10.
